(19) United States
(12) Patent Application Publication
(10) Pub. No.: US 2016/0071356 A1
(43) Pub. Date: Mar. 10, 2016

(54) SYSTEMS AND METHODS FOR MODIFYING A GAME INTERFACE OF AN ELECTRONIC CARD GAME BASED ON DATA RECEIVED FROM A PLAYER DEVICE

(71) Applicant: Gamesys Ltd., London (GB)

(72) Inventors: Jagbir Rehill, Middlesex (GB); Hans Elias, Hertfordshire (GB); Thomas David James Aicken, London (GB)

(21) Appl. No.: 14/929,272

(22) Filed: Oct. 31, 2015

Related U.S. Application Data
(63) Continuation of application No. PCT/US2015/028752, filed on May 1, 2015.
(60) Provisional application No. 61/987,484, filed on May 1, 2014.

(51) Int. Cl. G07F 17/32

(52) U.S. Cl. CPC G07F 17/3209; G07F 17/3293

(57) ABSTRACT

In accordance with some embodiments, a card game provides for a plurality of cards to be dealt in an unending finite sequence configuration of card positions (e.g., the card positions may be arranged in a circle configuration). A player may then select one of the card positions in the sequence when placing a wager. The card in the selected card position is revealed to the player, as are an additional number cards in the sequence in a particular direction of play (e.g., the next 4 cards, clockwise or counterclockwise, in the sequence), forming the player hand for the game. In some embodiments the player may choose the number of cards included in the player hand in addition to the card in the selected card position beginning from which the player hand is determined and/or the direction of play.

### CLAIM OF PRIORITY

This application is a Continuation application of PCT Application No. PCT/US15/028752, filed on May 1, 2015 in the name of Rehill et al. and titled SYSTEMS AND METHODS FOR FACILITATING A CARD GAME, which PCT Application claims the benefit of U.S. Provisional Application No. 61/987,484 filed on May 1, 2014 in the name of Rehill et al., titled SYSTEMS AND METHODS FOR FACILITATING A CARD GAME. The entirety of each of these applications is incorporated by reference herein for all purposes.

### BRIEF DESCRIPTION OF THE FIGURES

FIG. 1 is a schematic diagram of an embodiment of a gaming system in accordance with one or more embodiments described herein.

FIG. 2 is a schematic diagram of an embodiment of a social gaming platform in accordance with one or more embodiments described herein.

FIG. 3 is a block diagram of an embodiment of a computing device useful in a system according to one or more embodiments described herein.

FIGS. 4A and 4B comprise an example embodiment of a possible layout for card positions in a game interface consistent with some embodiments described herein, before and after dealt cards are revealed.

FIG. 5 comprises an alternate example embodiment of a possible layout for card positions in a game interface consistent with some embodiments described herein.

FIG. 6 comprises an alternate example embodiment of a possible layout for card positions in a game interface consistent with some embodiments described herein.

FIG. 7 is a flowchart of an example process consistent with one or more embodiments described herein.

### DETAILED DESCRIPTION OF EXAMPLE EMBODIMENTS

### I. Introduction

Embodiments described herein relate to a card game (e.g., an electronic card game playable online and/or via a player device) in which a plurality of cards are dealt (e.g., initially face-down) into a finite sequence of card positions, wherein the finite sequence of card positions includes positions 1 through n and wherein the sequence is continuous or wrap-around such that it has no termination point, irrespective of the physical arrangement of the card positions (e.g., whether the positions are arranged in a circle, rectangle or line). In accordance with some embodiments, the Position n in the finite sequence of card positions is considered to occur immediately prior to Position 1, irrespective of the physical arrangement of the positions. For example, if the card positions are arranged in a line such that the first position in the sequence is Position 1 and the last position in the sequence is Position n, the card placed in Position n is considered to be placed adjacent to (e.g., immediately before or after, depending on the direction the cards are being considered in) the card placed in Position 1 when evaluating the cards placed in the card positions for purposes of determining a composition of a hand of cards. In mathematical terms, the finite sequence of card positions may be considered similar to modular arithmetic, wherein the card position n is akin to the modulus at which the sequence resets or wraps around to the beginning of the sequence.

In accordance with some embodiments, a player selects a card position in the finite sequence of card positions (“the selected card position” or “initial card position”) and a composition of a hand for the player is determined based on (i) the card placed selected card position and (ii) X cards (X being either a predetermined number or a number selected by the player as a feature of the game) in the X card positions immediately before the selected card position and/or immediately after the selected card position. In some embodiments, the composition of the player's hand is determined based on the cards placed in card positions in a certain direction from the selected card position. The direction may be predetermined for the game or the player may be allowed to select, as a feature of the game, the direction. For example, the hand composition may be determined based on cards placed in card positions to the right (or clockwise, in a circular configuration) of the selected card position or to the left (or counter-clockwise, in a circular configuration) of the selected card position.

Table 1 below illustrates how a 5-card hand composition may be determined from the following 10 card position wrap-around finite sequence, wherein it may be assumed that the player has selected Position 8 as the selected card position (as indicated by the asterisk):

TABLE 1

| | | | | | | | Card | | Card |
|---|---|---|---|---|---|---|---|---|---|
| Card | Card | Card | Card | Card | Card | Card | Position | Card | Position |
| Position 1 | Position 2 | Position 3 | Position 4 | Position 5 | Position 6 | Position 7 | 8* | Position 9 | 10 |
| 6^{C} | 7^{H} | A^{C} | A^{H} | 9^{D} | K^{S} | 7^{S} | 3^{S} | 4^{D} | 5^{H} |

If, in accordance with one embodiment, the 5 card hand composition is determined to include the card in the selected card position and the next 4 cards to the right of the selected card position, the composition of the player's hand would be determined to be: 3^{S} (card in Card Position 8)-4^{D} (card in Card Position 9)-5^{H} (card in Card Position 10)-6^{C} (card in Card Position 1, since the sequence of card positions is a wrap-around sequence)-7^{H} (card in Card Position 2). This hand may be considered a Straight (any 5 consecutive cards of different suits) if standard poker hand rankings are utilized in the game and the player may be provided a corresponding payout in some embodiments. If, on the other hand, the 5 card hand composition is determined to include the card in the selected card position and the 4 cards in the card positions to the left of the selected card position in the sequence, the hand composition would be determined to be: A^{H} (card in Card Position 4)-9^{D} (card in Card Position 5)-K^{S} (card in Card Position 6)-7^{S} (card in Card Position 7)-3^{S} (card in Card Position 8). This hand, if standard poker hand rankings are utilized in the game, is not a winning hand.

In accordance with some embodiments, the player selects a card position as the selected card position prior to the values of the cards placed in the card position sequence being revealed (e.g., while the cards placed in the card positions are face down). The value of the cards in the selected card position and the other card positions utilized to determine the hand composition may then be revealed (e.g., turned face up) to indicate to the player the composition of the player's hand. In some embodiments, the values of the cards in the remaining card positions (i.e., card positions not being utilized to determine the composition of the player's hand) may also be revealed (e.g., to indicate any “near misses” to the player, such as cards comprising winning hands that could have been included in the player's hand had the player selected a different selected player position and/or different direction for card positions to be included in the player's hand).

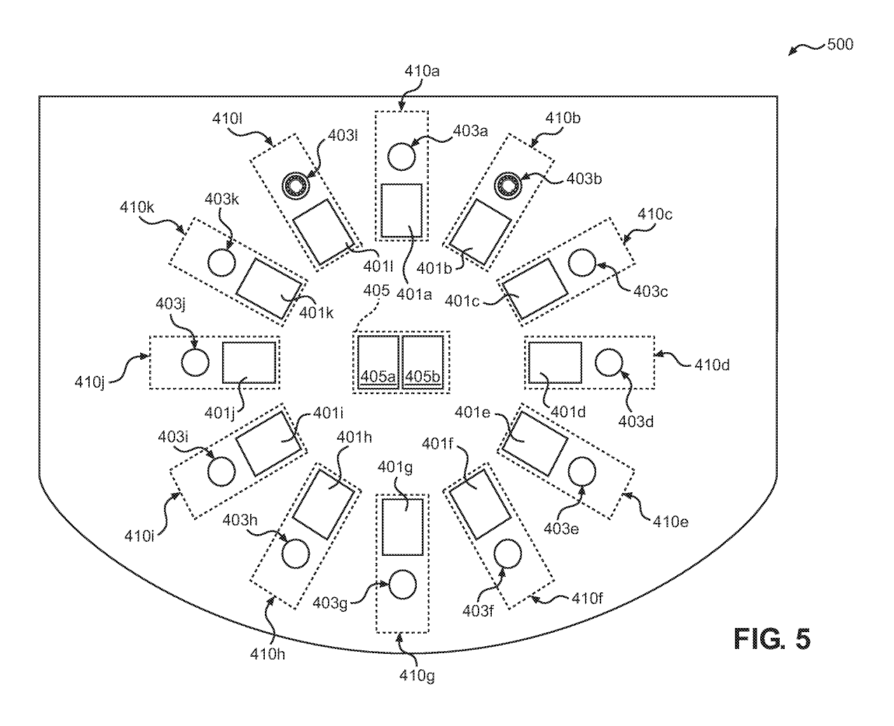

In accordance with some embodiments, the card positions may be configured in a circular configuration (e.g., as illustrated in FIGS. 5A and 5B), to more expressly indicate the wrap-around or continuous nature of the finite sequence of card positions.

In accordance with some embodiments, multiple hands may be determined from the same finite sequence of card positions and the cards placed into the card positions. For example, a single player may select more than one selected card position (each selected card position corresponding to a respective hand, in accordance with some embodiments). In a multi-player embodiments, each player of a plurality of players may select their own selected card position based upon which the player's hand is to be determined. In some embodiments, a particular card placed in a particular card position may be included in multiple hands. For example, referring again to Table 1 above and assuming a second player has selected Card Position 10 as his selected card position and the second player's hand composition is determined based on cards to the right of the selected card position, the player's hand may be determined to be: 5^{H} (the card in Card Position 10)-6^{C} (the card in Card Position 1)-7^{H} (the card in Card Position 2)-A^{C} (the card in Card Position 3)-A^{H} (the card in Card Position 4). This hand may be considered a One Pair (any 2 cards of the same rank) if standard poker hand rankings are utilized in the game and the second player may be provided a corresponding payout in some embodiments. If the hand for the first player (the player who, in the original example described above with reference to Table 1) was determined based on the cards to the right of Card Position 8, it can be appreciated that the cards in Card Position 10, Card Position 1 and Card Position 2 may be utilized to determine both the composition of the hand for the first player and the composition of the hand for the second player.

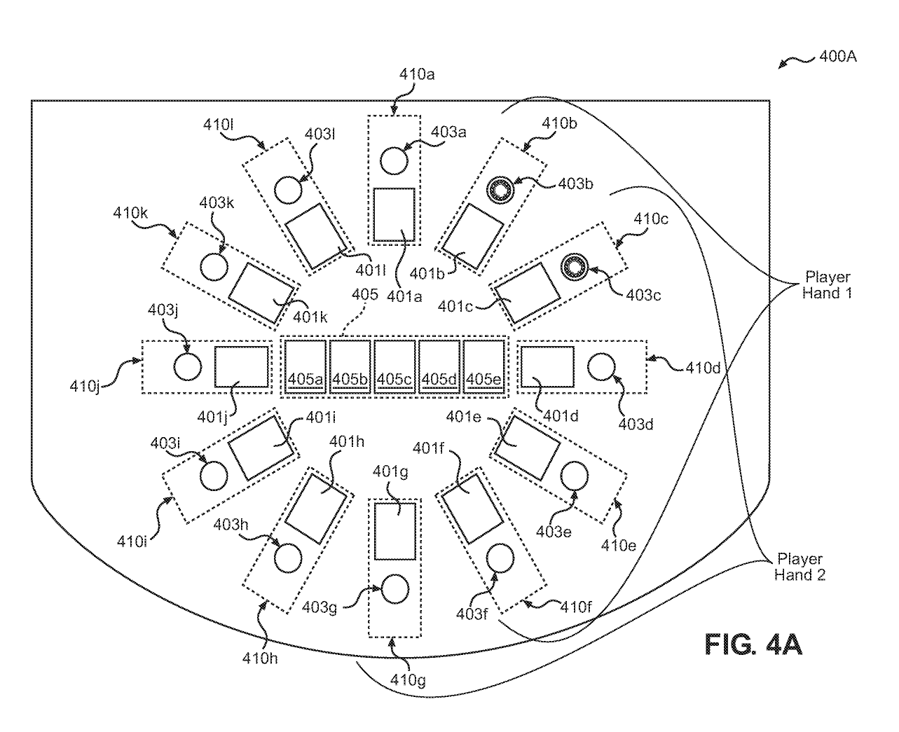

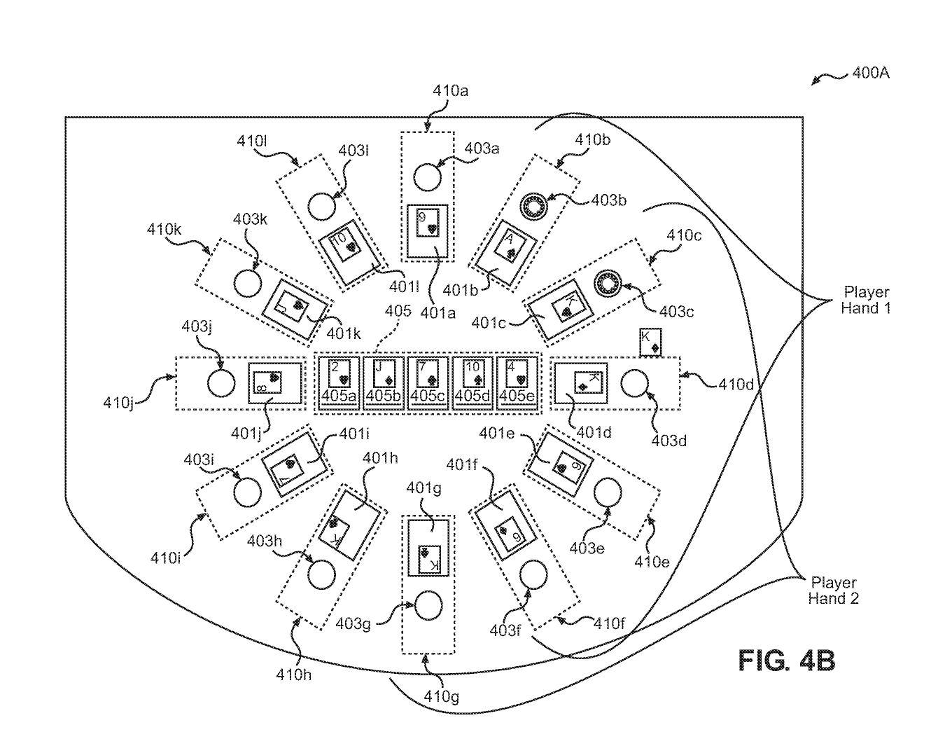

In accordance with some embodiments, systems, methods and articles of manufacture (e.g., non-transitory computer-readable media) provide for facilitating a card game by providing a game interface which includes a plurality of card positions into which cards are placed, the card positions being configured in a finite sequence arranged in an unending configuration having a first card position, a last card position and at least one card position between the first card position and the last card position, wherein the unending characteristic of the arrangement of the finite sequence of card positions provides that the last card position in the sequence is considered to occur immediately adjacent to first card position in the sequence irrespective of a physical placement of the last card position relative to the first card position. In one embodiment, the card position sequence may be arranged in a circle configuration (e.g., as illustrated in FIGS. 4A and 4B). In accordance with some embodiments, a plurality of cards are dealt, generated or determined for a game event (e.g., based on a random or pseudo-random algorithm, such as utilized by a Random Number Generator (RNG)) and a single card of the plurality of dealt cards is placed into each card position in the sequence of card positions, wherein at least one of the plurality of cards is placed such that it's value is not initially indicated to a player of the game (e.g., face down). In some embodiments, at least one card may be revealed (e.g., turned over or placed face up) to the player prior to a player finalizing a wager decision. For example, a card in a predetermined card position may be revealed (e.g., a card positions associated with the player, a predetermined card position along the circle in which the card positions are arranged or a randomly selected card position). In such embodiments, a player may thus have the benefit of knowing what at least one of the cards is and may make a selection of a card position based on this knowledge.

In accordance with some embodiments, an indication of a wager is received from the player (e.g., the player selects a wager amount, actuates a “wager” button or area of a touch screen etc.), the indication of the wager including a selection of one card position of the plurality of card positions. The card position selected by the player may be referred to herein as a selected card position. The player's hand may then be determined for the game event by, in one embodiment, defining or determining a subset of card positions within the sequence to be utilized in determining a composition of the player hand for the game event. In accordance with some embodiments, the subset includes the selected card position and at least one additional card position which is determined by: (a) determining a direction (e.g., clockwise or counterclockwise if the card positions are arranged in a circle configuration) of card positions in the finite sequence, from the selected card position, for selecting card positions to be included in the subset; (b) determining a number of card positions, in the direction and from the selected card position, to be included in the subset; and (c) selecting for the subset a plurality of consecutive card positions, up to the number determined in (b), which occur in the finite sequence in the direction determined in (a). In some embodiments, one or both of the direction and the number of cards to be included in the player's hand may be determined based on at least one rule of the game (e.g., the direction and number of cards are always the same or may be dependent based on a wager amount or other parameters associated with the player or the player's wager) while in other embodiments one or both of the direction and the number of cards may be selected by the player. The composition of the player's hand (i.e., the particular cards making up the player's hand) may then be determined by determining, for each card position included in the subset, a value of a card placed in the card position, thereby determining the composition of the player hand. If the player's hand is a winning hand, a payout or other prize may be provided to the player as a result of the hand.

The embodiments described herein may be applied to many different card games and are not limited to electronic card games. For example, at least some embodiments may be utilized in card game using real cards (e.g., a game playable on a card table in a casino). Other embodiments may be utilized in online card games (e.g., accessible via a web browser), software applications (e.g., downloadable game software for playing the card game) or in games embodied as software stored on tangible storage media such as a CD-ROM or a handheld game device.

Many popular versions of card games, including poker games, are played with one or more decks, each deck consisting of 52 cards, with winners are determined based on player hands including a plurality of cards (e.g., five card hands in a typical poker hand, two or more cards in a blackjack game, etc.). In some types of card games, whether a player hand is a winning hand is determined by comparing the player hand to a dealer hand (e.g., as in a blackjack game). In other types of card games, whether a player hand is a winning hand is determined by comparing the composition of the hand (i.e., the cards comprising the player hand) to a predetermined table or set of card combinations which are considered winning hands because they correspond to a payout or other prize. If the player hand matches or falls within a category defining a winning hand, the player hand may be determined to be a winning hand. For example, in a typical poker game, hands or combinations of cards are typically linearly ordered in terms of “rank.” For many games, there are nine general categories of hands, ranked as shown in Table 2. However, the embodiments described herein are not limited to poker-type card games or poker-type card games in which winning hands are limited to the nine categories of hands illustrated in Table 2. For example, in a blackjack-type card game the determination of whether a player's hand is a winning hand may be based on whether the value of the hand beats the value of a dealer's hand (or, in one embodiment, another player's hand) without exceeding the value of 21. In another embodiment, a determination of a winning hand may include determining whether the hand includes hi-low cards, all even, all odd, etc. A game provider may choose to define a winning hand in any manner desirable and the embodiments described herein are not limited to any particular types of winning hands or winning hand determinations or types of bets.

TABLE 2
Example Poker Hand Rankings

| | Name/ | | |
|---|---|---|---|
| Rank | Category | Explanation | Example |
| 1 | Royal Flush | A straight from a ten to an | A^{H} K^{H} Q^{H} J^{H} 10^{H} |
| | | ace with all five cards of the | |
| | | same suit. | |
| 2 | Straight | Any straight with all five | J^{D} 10^{D} 9^{D} 8^{D} 7^{D} |
| | Flush | cards of the same suit. | |
| 3 | Four of a | Any four cards of the same | K^{S} K^{D} K^{H} K^{C} 9 |
| | Kind | rank. | |
| 4 | Full House | Any three cards of the same | J^{D} J^{H} J^{S} 3^{H} 3^{D} |
| | | rank together with any two | |
| | | cards of the same rank. | |
| 5 | Flush | Any five cards of the same | A^{H} 10^{H} 9^{H} 5^{H} 2^{H} |
| | | suit (not consecutive). | |
| 6 | Straight | Any 5 consecutive cards of | 6^{H} 5^{D} 4^{C} 3^{H} 2^{D} |
| | | different suits. | |
| 7 | Three of a | Any three cards of the same | A^{S} A^{H} A^{D} K^{C} Q^{D} |
| | Kind | rank. | |
| 8 | Two Pair | Any two cards of the same | A^{H} A^{S} K^{H} K^{D} Q^{S} |
| | | rank together with another | |
| | | two cards of the same rank. | |
| 9 | One Pair | Any two cards of the same | A^{H} A^{S} K^{C} Q^{S} J^{D} |
| | | rank. | |
| 10 | High Card | Any hand not in the above- | A^{H} K^{S} Q^{D} J^{C} 9^{S} |
| | | mentioned hands. | |

Applicants have recognized that players who enjoy playing card games would appreciate a new type of card game with new betting opportunities which still allow for some player decisions during play (e.g., selecting the particular card position beginning with which a subset of the cards defining the player's hand is determined, determining now many cards are to be included in the player's hand and/or the direction in which cards for the player's hand are selected from the sequence of card positions). Such a game is described herein and may be, for example, a game playable online via a website or virtual casino establishment or a game playable on a physical table using real playing cards in a brick-and-mortar casino.

Certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Although several embodiments, examples and illustrations are described herein, it will be understood by those of ordinary skill in the art that the invention described herein extends beyond the specifically disclosed embodiments, examples and illustrations and includes other uses of the invention and obvious modifications and equivalents thereof. Embodiments of the invention(s) are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention(s). In addition, embodiments of the invention(s) can comprise several novel features and it is possible that no single feature is solely responsible for its desirable attributes or is essential to practicing the invention(s) herein described.

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting. Other terms are defined throughout the present description.

A “game”, as the term is used herein unless specified otherwise, may comprise any game (e.g., wagering or non-wagering, electronically playable over a network) playable by one or more players in accordance with specified rules. A game may be playable on a personal computer online in web browsers, on a game console and/or on a mobile device such as a smart-phone or tablet computer. A game may also be playable on a dedicated gaming device (e.g., an electronic or non-electronic table for facilitating card games in a brick-and-mortar casino). “Gaming” thus refers to play of a game.

A “casual game”, as the term is used herein unless specified otherwise, may comprise a game with simple rules with little or no time commitment on the time of a player to play. A casual game may feature, for example, very simple game play such as a puzzle or Scrabble™ game, may allow for short bursts of play (e.g., during work breaks), an ability to quickly reach a final stage and/or continuous play without a need to save the game.

A “social network game”, as used herein unless specified otherwise, refers to a type of online game that is played through a social network, and in some embodiments may feature multiplayer and asynchronous game play mechanics. A “social network” may refer to an online service, online community, platform, or site that focuses on facilitating the building of social networks or social relations among people. A social network service may, for example, consist of a representation of each user (often a profile), his/her social links, and a variety of additional services. A social network may be web-based and provide means for users to interact over the Internet, such as e-mail and instant messaging. A social network game may in some embodiments be implemented as a browser game, but can also be implemented on other platforms such as mobile devices.

A “wagering game”, as the term is used herein, may comprise a game on which a player can risk a wager or other consideration, such as, but not limited to: slot games, poker games, blackjack, baccarat, craps, roulette, lottery, bingo, keno, casino war, etc. A wager may comprise a monetary wager in the form of an amount of currency or any other tangible or intangible article having some value which may be risked on an outcome of a wagering game. “Gambling” or “wagering” refers to play of a wagering game.

The term “game provider”, as used herein unless specified otherwise, refers to an entity or system of components which provides, or facilitates the provision of, games for play and/or facilitates play of such game by use of a network such as the Internet or a proprietary or closed networks (e.g., an intranet or wide area network). For example, a game provider may operate a website which provides games in a digital format over the Internet. In some embodiments in which a game comprising a wagering game is provided, a game provider may operate or facilitate a gambling website over which wagers are accepted and results of wagering games are provided.

The terms “information” and “data”, as used herein unless specified otherwise, may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

The term “indication”, as used herein unless specified otherwise, may refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

The term “network component,” as used herein unless specified otherwise, may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

The term “player,” as used herein unless specified otherwise, may refer to any type, quantity, and or manner of entity associated with the play of a game. In some embodiments, a player may comprise an entity (i) conducting play of an online game, (ii) that desires to play a game (e.g., an entity registered and/or scheduled to play and/or an entity having expressed interest in the play of the game—e.g., a spectator) and/or may (iii) that configures, manages, and/or conducts a game. A player may be currently playing a game or have previously played the game, or may not yet have initiated play—i.e., a “player” may comprise a “potential player” (e.g., in general and/or with respect to a specific game). In some embodiments, a player may comprise a user of an interface (e.g., whether or not such a player participates in a game or seeks to participate in the game).

Some embodiments described herein are associated with a “player device” or a “network device”. As used herein, a “player device” is a subset of a “network device”. The “network device”, for example, may generally refer to any device that can communicate via a network, while the “player device” may comprise a network device that is owned and/or operated by or otherwise associated with a player. Examples of player and/or network devices may include, but are not limited to: a Personal Computer (PC), a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. Player and/or network devices may, in some embodiments, comprise one or more network components.

A “session” comprises a period of time spanning a plurality of event instances, game instances, spins or turns of a game, the session having a defined start and defined end. An “event instance”, “game instance”, “session” or “turn” is triggered upon an initiation of, or request for, at least one result of the game by a player, such as an actuation of a “start” or “spin” mechanism, which initiation causes an outcome to be determined or generated (e.g., a random number generator is contacted or communicated with to identify, generate or determine a random number to be used to determine a result for the event instance). An event instance or turn may comprise an event instance or turn of a primary game or an event instance or turn of a bonus round, mode or feature of the game. Accordingly, a session may refer to a session of a primary game or a session of a bonus round, mode or feature of the game, depending on the context.

An “outcome” should be differentiated from a “result” in the present description in that an “outcome” is a representation of a “result”, typically comprising one or more game elements or game symbols. For example, in a “fruit themed” game, a winning outcome (i.e., an outcome corresponding to some kind of award, prize or payout) may comprise a combination of three “cherry” symbols. The “result” of this outcome may be a payout of X credits awarded to the player associated with the game. In another example, in a card game an “outcome” of the game may comprise a plurality of cards defining the player's hand and the “result” corresponding to this outcome may be the payout or other prize, if any, corresponding to the particular plurality of cards that the player wins based on the cards in the player's hand. In a session embodiment, a session result may comprise a binary result (e.g., a player or game character wins or loses the session) and/or the particular award (or magnitude of award) won or earned by the player based on the session (e.g., the number of credits awarded to the player). It should be noted that the embodiments described herein encompass prizes which may comprise awards, payouts, discounts, eligibility, advancement in a game or other benefits (whether monetary or non-monetary, tangible or intangible) to a player and that any reference to a “prize”, “award” or “payout” may refer to any or all of the foregoing, unless the context explicitly indicates otherwise.

A “bonus round”, “bonus mode” or “bonus feature” of a game, as the terms are used interchangeably herein unless indicated otherwise, may refer to a secondary game, entry into which is triggered via one or more events which may occur in a base or primary game. Typically, a player may be able to qualify to play a bonus game based on one or more outcomes in a primary game, such as in a basic mode or a qualifying mode. A bonus round may be played in accordance with a set of rules that is different from those of a primary game, and may be accompanied by displays, colors, sounds, animated sequences, game play and/or prizes that are not part of the primary game. In one embodiment, a primary or base game application or program may include programming or instructions which will automatically begin a bonus round after the player has achieved a triggering event or qualifying condition in the base or primary game.

“Virtual currency” as the term is used herein unless indicated otherwise, refers to an in-game currency that may be used as part of a game or one or more games provided by a game provider as (i) currency for making wagers, and/or (ii) to purchase or access various in-game items, features or powers. References to an “award”, “prize” and/or “payout” herein are intended to encompass such in the form of virtual currency, credits, real currency or any other form of value, tangible or intangible.

A “credit balance”, as the term is used herein unless indicated otherwise, refers to (i) a balance of currency, whether virtual currency or real currency, usable for making wagers or purchases in the game (or relevant to the game), and/or (ii) another tracking mechanism for tracking a player's success or advancement in a game by deducting therefrom points or value for unsuccessful attempts at advancement and adding thereto points or value for successful attempts at advancement. A credit balance may be increased or replenished with funds external to the game. For example, a player may transfer funds to the credit balance from a financial account or a gaming establishment may add funds to the credit balance due to a promotion, award or gift to the player.

### II. Description of Figures: Example Systems

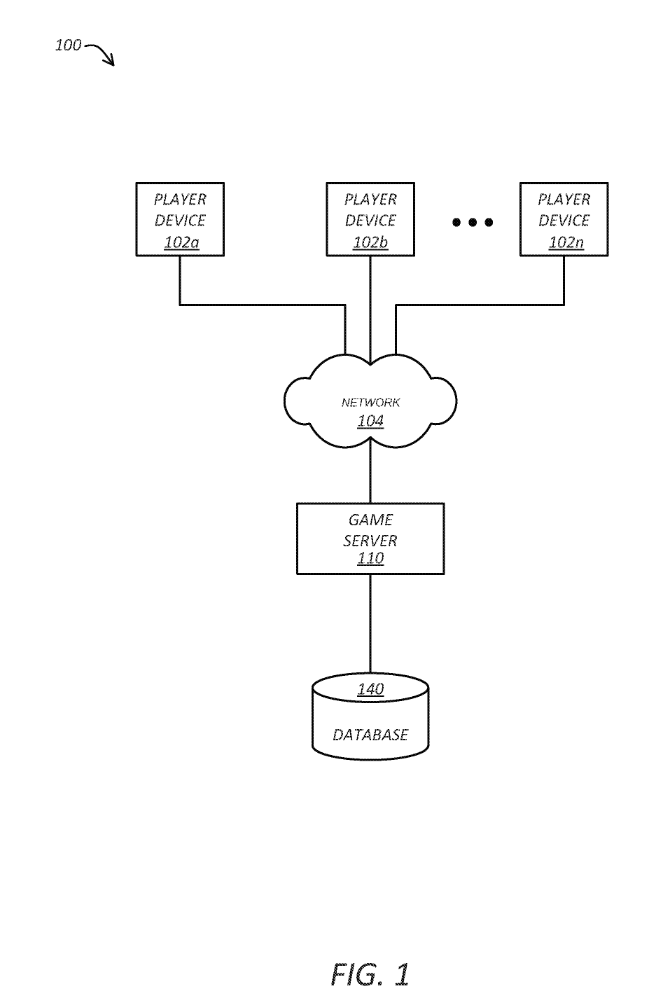

Referring now to the figures, FIG. 1 depicts a block diagram of an example system 100 according to some embodiments. The system 100 may comprise a plurality of player devices 102a-102n in communication with a game server 110 via a network 104. For purposes of brevity, any or all of the player devices 102a-102n will be referred to as a player device 102 herein, even though the plurality of player devices 102a-102n may include different types of player devices (as described below). The game server 110 may also be operable to communicate with or access a database 140 (which may comprise one or more databases and/or tables and which may comprise a storage device distinct from (or be a component of) the game server 110). It should be noted that in some embodiments database 140 may be stored on a game server 110 while in other embodiments database 140 may be stored on another computing device with which game server 110 is operable to communicate in order to at least access the data in database 140 (e.g., another server device remote from game server 140, operable to determine outcomes for an event instance of a game). In some embodiments a processor (e.g., one or more microprocessors, one or more microcontrollers, one or more digital signal processors) of a player device 102 and/or game server 110 may receive instructions (e.g., from a memory or like device), and execute those instructions, thereby performing one or more processes defined by those instructions. Instructions may be embodied in, e.g., one or more computer programs and/or one or more scripts.

In some embodiments a game server 110 and/or one or more of the player devices 102 stores and/or has access to data useful for facilitating play of a game. For example, game server 110 and/or a player device 102 may store (i) one or more probability databases for determining one or more outcome(s) and/or results for an event instance, hand or turn of a game, (ii) a current state or status of a game or game session (e.g., an indication of one or more wagers a player has placed on a plurality of dealt cards, including the selected card position corresponding to each wager), (iii) one or more user interfaces for use in a game, (iv) one or more game themes for a game and/or (v) profiles or other personal information associated with a player of a game. It should be noted that in some embodiments such data may be stored on the game server 110 and information based on such data may be output to a player device 102 during play of a game while in other embodiments a game program may be downloaded to a local memory of a player device 102 and thus such data may be stored on a player device 102 (e.g., in encrypted or other secure or tamper-resistant form).

A game server 110 may comprise a computing device for facilitating play of a game (e.g., by receiving an input from a player, determining an outcome for a game, causing an outcome of a game to be displayed on a player device, determining whether to substitute or output a Blended Symbol at a particular symbol position of a game interface, facilitating a wager and/or a provision of a payout for a game). For example, the game server 110 may comprise a server computer operated by a game provider or another entity (e.g., a social network website not primarily directed at providing games). In some embodiments, the game server may determine an outcome for spin of a game by requesting and receiving such an outcome from another remote server operable to provide such outcomes. In some embodiments, the game server 110 may further be operable to facilitate a game program for a game (e.g., a wagering game).

In accordance with some embodiments, in addition to administering or facilitating play of a game, a game server 110 may comprise one or more computing devices responsible for handling online processes such as, but not limited to: serving a website comprising one or more games to a player device and/or processing transactions (e.g., wagers, deposits into financial accounts, managing accounts, controlling games, etc.). In some embodiments, game server 110 may comprise two or more server computers operated by the same entity (e.g., one server being primarily for storing states of games in progress and another server being primarily for storing mechanisms for determining outcomes of games, such as a random number generator). Examples of processes that may be performed by the game server 110 (directly or indirectly) may include, but are not limited to: (i) determining a plurality of cards to be dealt for a game event or round of a game; (ii) placing the dealt cards into card positions and storing in memory which card or card value has been placed in which card position; (iii) receiving an indication of a wager from a player, including a selected card position selected by the player for his/her hand; (iv) determining a number of cards and/or direction in which additional card positions will be selected to form a player hand from the plurality of dealt and placed cards (if the number of cards and/or direction are not selected by the player but are pre-determined based on one or more rules of the game, this step may at least partially be unnecessary); (v) determining the player's hand by selecting a subset of the dealt cards based on the selected card position, direction and number of cards to be included in the player's hand; (vi) revealing one or more cards to a player (e.g., by placing the one or more cards face-up; this can be done after a wager is received and, in some embodiments, prior to a wager being received for at least some of the dealt cards); (vii) authorizing a game program to be downloaded to a player device; (viii) dealing one or more cards to a dealer hand (in embodiments in which a dealer hand is utilized); (ix) determining whether the player's hand is a winning hand; and/or (x) modifying (or directing a player device to modify) a game interface to output information to a player, such as the cards comprising the player's hand (e.g., turning each of the cards in the player's hand face up), turning cards not in the player's hand face up, indicating whether the player's hand is a winning hand, updating a credit meter to reflect a payout won by the player, etc.

Turning now to a description of a player device 102, in accordance with some embodiments a player device 102 may comprise a computing device that is operable to execute or facilitate the execution of a game program and used or useful by an online player for accessing an online casino or other electronic (e.g., online) game provider. For example, a player device 102 may comprise a desktop computer, computer workstation, laptop, mobile device, tablet computer, Personal Digital Assistant (PDA) devices, cellular or other wireless telephones (e.g., the Apple™ iPhone™), video game consoles (e.g., Microsoft™ Xbox 360™, Sony™ PlayStation™, and/or Nintendo™ Wii™), and/or handheld or portable video game devices (e.g., Nintendo™ Game Boy™ or Nintendo™ DS™). A player device 102 may comprise and/or interface with various components such as input and output devices (each of which is described in detail elsewhere herein) and, in some embodiments, game server 110. A player device 102 may be a dedicated gaming device (e.g., a slot machine) or a non-dedicated gaming device (e.g., an iPad™). It should be noted that a game server 110 may be in communication with a variety of different types of player devices 102.

A player device 102 may be used to play a wagering or non-wagering game (e.g., a social or casual game) over a network and output information relating to the game to players participating in the game (e.g., cards dealt and placed into card positions for round of the game, card values of the cards making up a player hand, values of all cards dealt for the game (e.g., to show any “near misses” based on the player's selection of a selected card position based upon which the composition of the player's hand was determined, credit balance of credits available for play of the game, a session result for a session of the game, etc.). Any and all information relevant to any of the aforementioned functions may be stored locally on one or more of the player devices 102 and/or may be accessed using one or more of the player devices 102 (in one embodiments such information being stored on, or provided via, the game server 110). In another embodiment, a player device 102 may store some or all of the program instructions for determining, for example, (i) that a player has placed a wager in a round of the game (and, in some embodiments, communicating an indication of such a wager to game server 110), (ii) a composition of a player's hand based on a selected card position and the cards dealt and placed into card positions arranged in a finite sequence of card positions arranged in an unending configuration; (iii) one or more results of wagers placed on the round of the game and/or (iv) one or more results of any side wagers placed on the round of the game. In some embodiments, the game server 110 may be operable to authorize the one or more player devices 102 to access such information and/or program instructions remotely via the network 104 and/or download from the game server 110 (e.g., directly or via an intermediary server such as a web server) some or all of the program code for executing one or more of the various functions described in this disclosure. In other embodiments, outcome and result determinations may be carried out by the game server 110 (or another server with which the game server 110 communicates) and the player devices 102 may be terminals for displaying to an associated player such outcomes and results and other graphics and data related to a game.

It should be noted that the one or more player devices 102 may each be located at the same location as at least one other player device 102 (e.g., such as in a casino or internet café) or remote from all other player devices 102. Similarly, any given player device may be located at the same location as the game server 110 or may be remote from the game server 110. It should further be noted that while the game server 110 may be useful or used by any of the player devices 102 to perform certain functions described herein, the game server 110 need not control any of the player devices 102. For example, in one embodiment the game server 110 may comprise a server hosting a website of an online casino accessed by one or more of the player devices 102.

In one embodiment, a game server 110 may not be necessary or desirable. For example, some embodiments described in this disclosure may be practiced on one or more player devices 102 without a central authority. In such an embodiment, any functions described herein as performed by a game server 110 and/or data described as stored on a game server 110 may instead be performed by or stored on one or more player devices 102. Additional ways of distributing information and program instructions among one or more player devices 102, a game server 110 and/or another server device will be readily understood by one skilled in the art upon contemplation of the present disclosure.

In one embodiment, neither a game server nor a player device is necessary or desirable. For example, a card game consistent with the embodiments described herein may be implemented on a physical, non-electronic card table which utilizes physical cards.

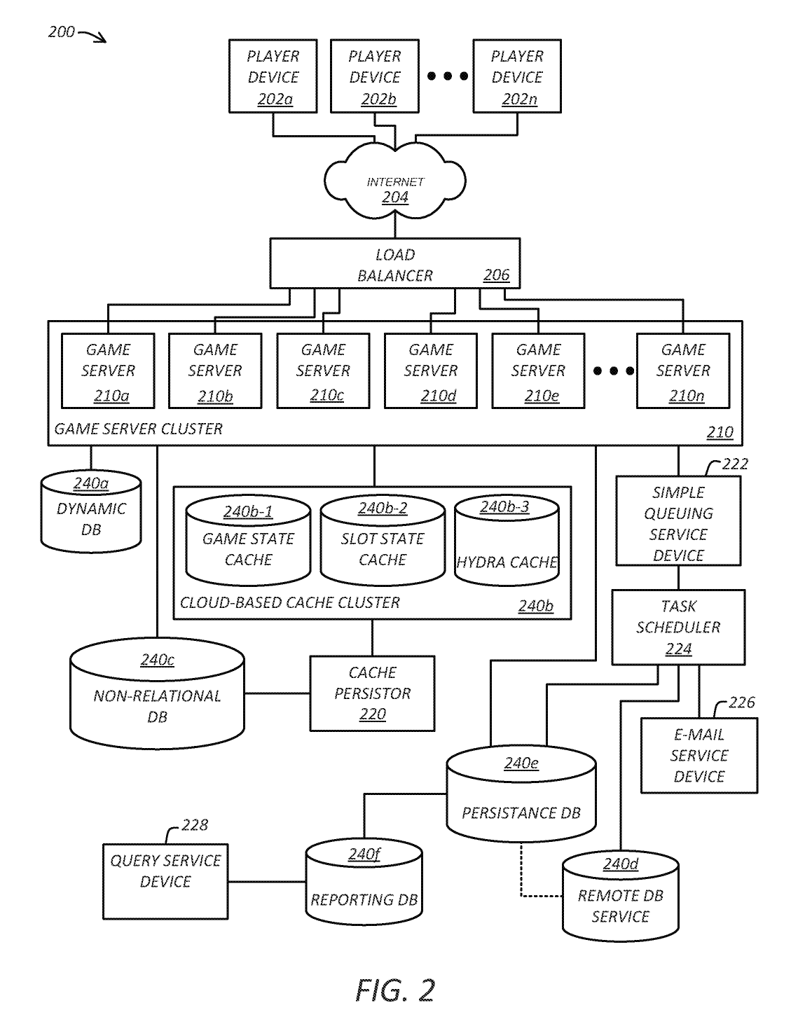

FIG. 2 a block diagram of an example system 200, which is consistent with some embodiments. In accordance with some embodiments, the system 200 may comprise a plurality of player devices 202a-n, the Internet 204, a load balancer 206, and/or a game server cluster 210. The game server cluster 210 may, in some embodiments, comprise a plurality of game servers 210a-n. In some embodiments, the system 200 may comprise a cache persistor 220, a Simple Queuing Service (SQS) device 222, a task scheduler 224, an e-mail service device 226, and/or a query service device 228. As depicted in FIG. 2, any or all of the various components 202a-n, 204, 206, 210a-n, 220, 222, 224, 226, 228 may be in communication with and/or coupled to one or more databases 240a-f. The system 200 may comprise, for example, a dynamic DataBase (DB) 240a, a cloud-based cache cluster 240b (e.g., comprising a game state cache 240b-1, a slot state cache 240b-2, and/or a “hydra” cache 240b-3), a non-relational DB 240c, a remote DB service 240d, a persistence DB 240e, and/or a reporting DB 240f.

According to some embodiments, any or all of the components 202a-n, 204, 206, 210a-n, 220, 222, 224, 226, 228, 240a-f of the system 200 may be similar in configuration and/or functionality to any similarly named and/or numbered components described herein. Fewer or more components 202a-n, 204, 206, 210a-n, 220, 222, 224, 226, 228, 240a-f (and/or portions thereof) and/or various configurations of the components 202a-n, 204, 206, 210a-n, 220, 222, 224, 226, 228, 240a-f may be included in the system 200 without deviating from the scope of embodiments described herein. While multiple instances of some components 202a-n, 210a-n, 240a-f are depicted and while single instances of other components 204, 206, 220, 222, 224, 226, 228 are depicted, for example, any component 202a-n, 204, 206, 210a-n, 220, 222, 224, 226, 228, 240a-f depicted in the system 200 may comprise a single device, a combination of devices and/or components 202a-n, 204, 206, 210a-n, 220, 222, 224, 226, 228, 240a-f, and/or a plurality of devices, as is or becomes desirable and/or practicable. Similarly, in some embodiments, one or more of the various components 202a-n, 204, 206, 210a-n, 220, 222, 224, 226, 228, 240a-f may not be needed and/or desired in the system 200.

According to some embodiments, the player device 202a-n may be utilized to access (e.g., via the Internet 204 and/or one or more other networks not explicitly shown) content provided by the game server cluster 210. The game server cluster 210 may, for example, provide, manage, host, and/or conduct various online and/or otherwise electronic games such as online bingo, slots, poker, and/or other games of chance, skill, and/or combinations thereof. In some embodiments, the various game servers 210a-n (virtual and/or physical) of the game server cluster 210 may be configured to provide, manage, host, and/or conduct individual instances of available game types. A first game server 210a, for example, may host a first particular instance of an online card game, a second game server 210c may host a second particular instance of an online card game, a third game server 210c may facilitate an online poker tournament, and/or a fourth game server 210d may provide an online slots game.

In some embodiments, the player devices 202a-n may comprise various components (hardware, firmware, and/or software; not explicitly shown) that facilitate game play and/or interaction with the game server cluster 210. The player device 202a-n may, for example, comprise a gaming client such as a software application programmed in Adobe® Flash® and/or HTML 5 that is configured to send requests to, and receive responses from, one or more of the game servers 210a-n of the game server cluster 210. In some embodiments, such an application operating on and/or via the player devices 202a-n may be configured in Model-View-Controller (MVC) architecture with a communication manager layer responsible for managing the requests to/responses from the game server cluster 210. In some embodiments, one or more of the game servers 210a-n may also or alternatively be configured in a MVC architecture with a communication manager and/or communications management layer. In some embodiments, communications between the player devices 202a-n and the game server cluster 210 may be conducted in accordance with the HyperText Transfer Protocol (HTTP) version 1.1 (HTTP/1.1) as published by the Internet Engineering Taskforce (IET) and the World Wide Web Consortium (W3C) in RFC 2616 (June 1999).

According to some embodiments, communications between the player devices 202a-n and the game server cluster 210 may be managed and/or facilitated by the load balancer 206. The load balancer 206 may, for example, route communications from player devices 202a-n to one or more of the specific game servers 210a-n depending upon various attributes and/or variables such as bandwidth availability (e.g., traffic management/volumetric load balancing), server load (e.g., processing load balancing), server functionality (e.g., contextual awareness/availability), and/or player-server history (e.g., session awareness/stickiness). In some embodiments, the load balancer 206 may comprise one or more devices and/or services provided by a third-party (not shown). The load balancer 206 may, for example, comprise an Elastic Load Balancer (ELB) service provided by Amazon® Web Services, LLC of Seattle, Wash. According to some embodiments, such as in the case that the load balancer 206 comprises the ELB or a similar service, the load balancer 206 may manage, set, determine, define, and/or otherwise influence the number of game servers 210a-n within the game server cluster 210. In the case that traffic and/or requests from the player devices 202a-n only require the first and second game servers 210a-b, for example, all other game servers 210c-n may be taken off-line, may not be initiated and/or called, and/or may otherwise not be required and/or utilized in the system 200. As demand increases (and/or if performance, security, and/or other issues cause one or more of the first and second game servers 210a-b to experience detrimental issues), the load balancer 206 may call and/or bring online one or more of the other game servers 210c-n depicted in FIG. 2. In the case that each game server 210a-n comprises an instance of an Amazon® Elastic Compute Cloud (EC2) service, the load balancer 206 may add or remove instances as is or becomes practicable and/or desirable.

In some embodiments, the load balancer 206 and/or the Internet 204 may comprise one or more proxy servers and/or devices (not shown in FIG. 2) via which communications between the player devices 202a-n and the game server cluster 210 are conducted and/or routed. Such proxy servers and/or devices may comprise one or more regional game hosting centers, for example, which may be geographically dispersed and addressable by player devices 202a-n in a given geographic proximity. In some embodiments, the proxy servers and/or devices may be located in one or more geographic areas and/or jurisdictions while the game server cluster 210 (and/or certain game servers 210a-n and/or groups of game servers 210a-n thereof) is located in a separate and/or remote geographic area and/or jurisdiction.

According to some embodiments, for some game types the game server cluster 210 may provide game outcomes to a controller device (not separately shown in FIG. 2) that times the release of game outcome information to the player devices 202a-n such as by utilizing a broadcaster device (also not separately shown in FIG. 2) that transmits the time-released game outcomes to the player devices 202a-n (e.g., in accordance with the Transmission Control Protocol (TCP) and Internet Protocol (IP) suite of communications protocols (TCP/IP), version 4, as defined by “Transmission Control Protocol” RFC 793 and/or “Internet Protocol” RFC 791, Defense Advance Research Projects Agency (DARPA), published by the Information Sciences Institute, University of Southern California, J. Postel, ed. (September 1981)).

In some embodiments, the game server cluster 210 (and/or one or more of the game servers 210a-n thereof) may be in communication with the dynamic DB 240a. According to some embodiments, the dynamic DB 240a may comprise a dynamically-scalable database service such as the DyanmoDB™ service provided by Amazon® Web Services, LLC. The dynamic DB 240a may, for example, store information specific to one or more certain game types (e.g., a reeled slots themed game) provided by the game server cluster 210 such as to allow, permit, and/or facilitate reporting and/or analysis of such information.

According to some embodiments, the game server cluster 210 (and/or one or more of the game servers 210a-n thereof) may be in communication with the cloud-based cache cluster 240b. Game state information from the game server cluster 210 may be stored in the game state cache 240b-1, for example, slot state (e.g., slot-game specific state) data may be stored in the slot state cache 240b-2, and/or other game and/or player information (e.g., progressive data, player rankings, audit data) may be stored in the hydra cache 240b-3. In some embodiments, the cache persistor 220 may move and/or copy data stored in the cloud-based cache cluster 240b to the non-relational DB 240c. The non-relational DB 240c may, for example, comprise a SimpleDB™ service provided by Amazon® Wed Services, LLC. According to some embodiments, the game server cluster 210 may generally access the cloud-based cache cluster 240b as-needed to store and/or retrieve game-related information. The data stored in the cloud-based cache cluster 240b may generally comprise a subset of the newest or freshest data, while the cache persistor 220 may archive and/or store or move such data to the non-relational DB 240c as it ages and/or becomes less relevant (e.g., once a player logs-off, once a game session and/or tournament ends). The game server cluster 210 may, in accordance with some embodiments, have access to the non-relational DB 240c as-needed and/or desired. The game servers 210a-n may, for example, be initialized with data from the non-relational DB 240c and/or may store and/or retrieve low frequency and/or low priority data via the non-relational DB 240c.

In some embodiments, the SQS device 222 may queue and/or otherwise manage requests, messages, events, and/or other tasks or calls to and/or from the server cluster 210. The SQS device 222 may, for example, prioritize and/or route requests between the game server cluster 210 and the task scheduler 224. In some embodiments, the SQS device 222 may provide mini-game and/or tournament information to the server cluster 210. According to some embodiments, the task scheduler 224 may initiate communications with the SQS device 222, the e-mail service provider 226 (e.g., providing e-mail lists), the remote DB service 240d (e.g., providing inserts and/or updates), and/or the persistence DB 240e (e.g., providing and/or updating game, player, and/or other reporting data), e.g., in accordance with one or more schedules.

According to some embodiments, the persistence DB 240e may comprise a data store of live environment game and/or player data. The game server cluster 210 and/or the task scheduler 224 or SQS device 222 may, for example, store game and/or player data to the persistence DB 240e and/or may pull and/or retrieve data from the persistence DB 240e, as-needed and/or desired. The server cluster 210 may, according to some embodiments, provide and/or retrieve spin and/or other game event info and/or configuration information via the persistence DB 240e.

In some embodiments, the reporting DB 240f may be created and/or populated based on the persistence DB 240e. On a scheduled and/or other basis, for example, a data transformation and/or mapping program may be utilized to pull data from the live environment (e.g., the persistence DB 240e) into the reporting DB 240f. The query service 228 may then be utilized, for example, to query the reporting DB 240f, without taxing the live environment and/or production system directly accessible by the game server cluster 210.

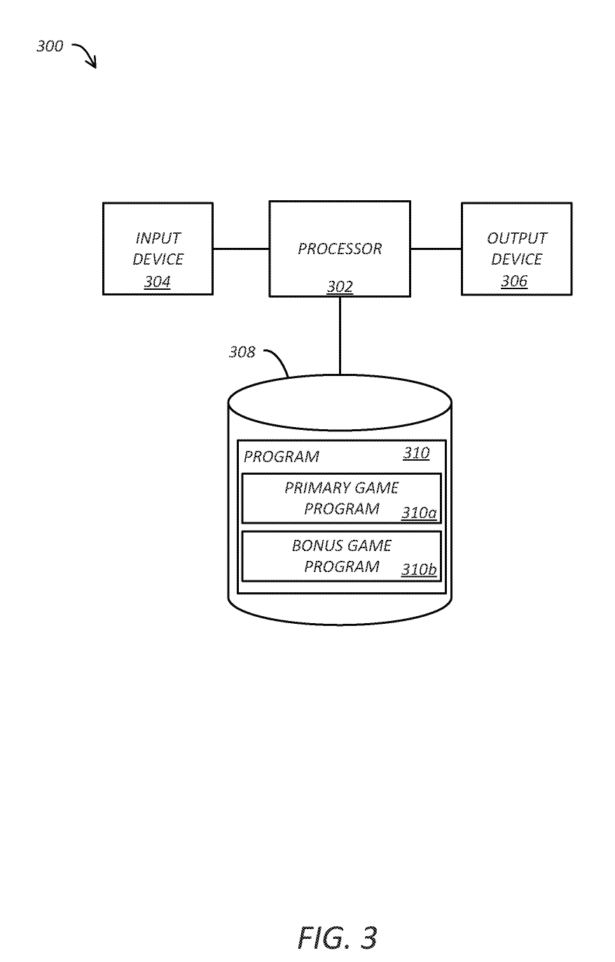

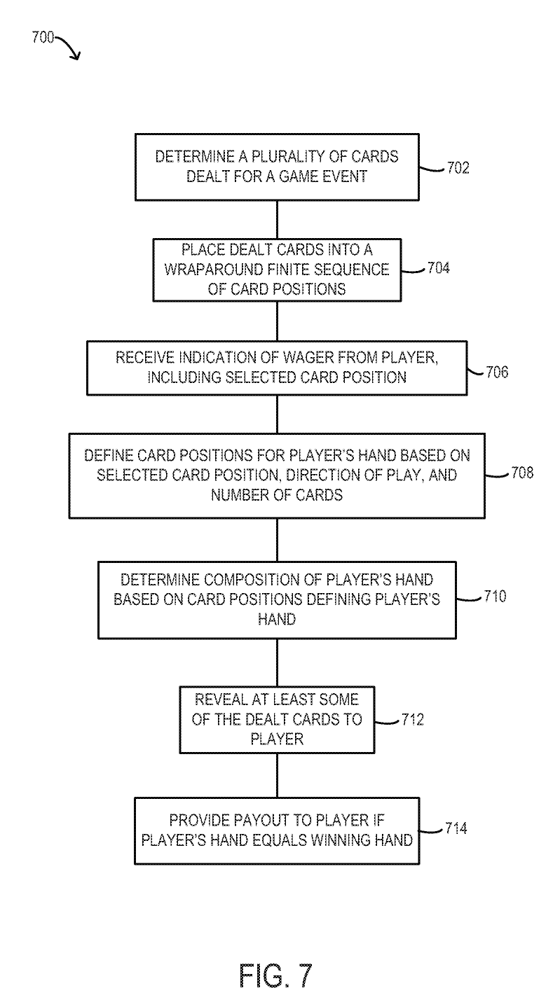

FIG. 3 is a block diagram of an apparatus 300 according to some embodiments. In some embodiments, the apparatus 300 may be similar in configuration and/or functionality to any of the player devices 102, the game server 110 and/or another server device operable to facilitate the embodiments described herein. The apparatus 300 may, for example, execute, process, facilitate, and/or otherwise be associated with any of the process 700 described herein in conjunction with FIG. 7.

In some embodiments, the apparatus 300 may comprise a processor 302, an input device 304, an output device 306 and/or a memory device 308. Fewer or more components and/or various configurations of the components 302, 304, 306 and/or 308 may be included in the apparatus 300 without deviating from the scope of embodiments described herein.

According to some embodiments, the processor 302 may be or include any type, quantity, and/or configuration of processor that is or becomes known. The processor 302 may comprise, for example, an Intel® IXP 2800 network processor or an Intel® XEON™ Processor coupled with an Intel® E7501 chipset. In some embodiments, the processor 302 may comprise multiple inter-connected processors, microprocessors, and/or micro-engines. According to some embodiments, the processor 302 (and/or the apparatus 300 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 302 comprises a server such as a blade server, necessary power may be supplied via a standard AC outlet, power strip, surge protector, and/or Uninterruptible Power Supply (UPS) device.

In some embodiments, the input device 304 and/or the output device 306 are communicatively coupled to the processor 302 (e.g., via wired and/or wireless connections and/or pathways) and they may generally comprise any types or configurations of input and output components and/or devices that are or become known, respectively.

The input device 304 may comprise, for example, a keyboard that allows an operator of the apparatus 300 to interface with the apparatus 200 (e.g., by a player, an employee or other worker affiliated with either an online casino or other entity operating a system which provides games to players). In some embodiments, the input device 304 may comprise a mechanism configured to indicate to a remote server device an initiation or triggering of an event instance or a request for a result of a game event (e.g., that a player has placed a wager for a game event and provided data sufficient to define the player's hand for the game event, such as a selected card position, number of cards and/or direction in which additional card positions for the hand are to be selected), such information being provided to the apparatus 300 and/or the processor 302. In such embodiments, the input device may comprise a key on a keyboard of the apparatus 300. Other examples of input devices include, but are not limited to: a game controller and/or gamepad, a bar-code scanner, a magnetic stripe reader, a pointing device (e.g., a computer mouse, touchpad, and/or trackball), a point-of-sale terminal keypad, a touch-screen, a microphone, an infrared sensor, a sonic ranger, a computer port, a video camera, a motion detector, a digital camera, a network card, a Universal Serial Bus (USB) port, a GPS receiver, a Radio Frequency Identification (RFID) receiver, a RF receiver, a thermometer, a pressure sensor, and a weight scale or mass balance.

The output device 306 may, according to some embodiments, comprise a display screen and/or other practicable output component and/or device that is operable to output information. The output device 306 may, for example, comprise a display screen via which is output a user interface for indication information to a player, such as values of cards or other outcomes, instructions, guidance, questions or other game-related information. Some examples of output devices that may be useful in some embodiments include a Cathode Ray Tube (CRT) monitor, a Liquid Crystal Display (LCD) screen, a Light Emitting Diode (LED) screen, a printer, an audio speaker, an Infra-red Radiation (IR) transmitter, an RF transmitter, and/or a data port. According to some embodiments, the input device 304 and/or the output device 306 may comprise and/or be embodied in a single device such as a touch-screen display or screen.

In some embodiments, the apparatus 300 may comprise any type or configuration of communication device and/or protocol (not shown) that is or becomes known or practicable. For example, the apparatus 300 may include a communication device such as a Network Interface Controller (NIC), a telephonic device, a cellular network device, a router, a hub, a modem, and/or a communications port or cable. In some embodiments, the communication device may be coupled to provide data to a telecommunications device. The communication device may, for example, comprise a cellular telephone network transmission device that sends signals (e.g., a placement of a wager and/or request for defining a player hand based on an input from a player) to a server (e.g., game server 110) in communication with a plurality of player devices 102. According to some embodiments, the communication device may also or alternatively be coupled to the processor 302. In some embodiments, the communication device may comprise an IR, RF, Bluetooth™, and/or Wi-Fi® network device coupled to facilitate communications between the processor 202 and another device.

The memory device 308 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM).

The memory device 308 may, according to some embodiments, store a program 310 for facilitating one or more of the embodiments described herein, which program may include a primary game program 310a for facilitating a primary aspect of a game. In some embodiments, a game may further include a bonus round and the program 310 may further include a bonus round program 310b for facilitating the bonus round of the game. In some embodiments, the primary game program 310a and/or the bonus round program 310b may be utilized by the processor 302 to provide output information via the output device 306.

The primary game program 310a may, for example, provide instructions for determining at least one of: (i) a plurality of cards to be dealt for a round or event of a game (e.g., cards to be dealt into card positions upon which players may place bets); (ii) placement of the dealt cards into card positions of a finite sequence of card positions arranged in an unending configuration; (iii) that a player has placed a wager for the round or event of the game; (iv) information upon which a player hand for the player is to be defined, such as the selected card position (and, in some embodiments, a number of cards and/or direction from the selected card positions in which additional card positions defining the hand are to be selected); (v) a composition of the player hand based on a subset of the dealt cards, which subset is selected based on the information in (iv); (vi) whether the player hand is a winning hand (e.g., by comparing the composition of the player hand to a composition of a dealer hand or a table of winning categories of hands); (vi) whether a player has placed a side wager (e.g., based on an overlap of card positions in two or more wagers placed by the player for the game event); (vii) whether the player has changed the selected card position for a wager, thereby triggering a re-defining of the player's hand; and/or (viii) whether any card values are to be revealed to the player and, if so, causing the appropriate card values to be revealed.

The apparatus 300 may function as a computer terminal and/or server of an online casino or other entity operating to provide online games, receive and/or manage information related to online games. In some embodiments, the apparatus 300 may comprise a web server and/or other server device operable to accept wagers and determine random numbers based upon which outcomes for wagering games are determined. In some embodiments, the apparatus 300 may comprise an apparatus that is operable to interact with a player of an online game. In some embodiments, apparatus 300 may comprise a plurality of devices working together to accomplish the functionality described herein with respect to FIG. 3.

Any or all of the exemplary instructions and data types described herein and other practicable types of data may be stored in any number, type, and/or configuration of memory devices that is or becomes known. The memory device 308 may, for example, comprise one or more data tables or files, databases, table spaces, registers, and/or other storage structures. In some embodiments, multiple databases and/or storage structures (and/or multiple memory devices 308) may be utilized to store information associated with the apparatus 300. According to some embodiments, the memory device 308 may be incorporated into and/or otherwise coupled to the apparatus 300 (e.g., as shown) or may simply be accessible to the apparatus 200 (e.g., externally located and/or situated).

Turning now to FIGS. 4A and 4B, illustrated therein is an example game interface, each illustrating an example layout of a finite sequence of card positions arranged in an unending configuration into which cards may be placed for a particular game event, upon which game event one or more players may place one or more wagers in accordance with embodiments described herein. FIG. 4A comprises a state of the game interface at a first stage of a game event, before card values are revealed, while FIG. 4B comprises a second stage of the game event, after card values are revealed. In the present application, like reference numerals in the Figures refer to like elements. For example, the same card position in FIG. 4A and FIG. 4B may be referred to using the same reference numeral.

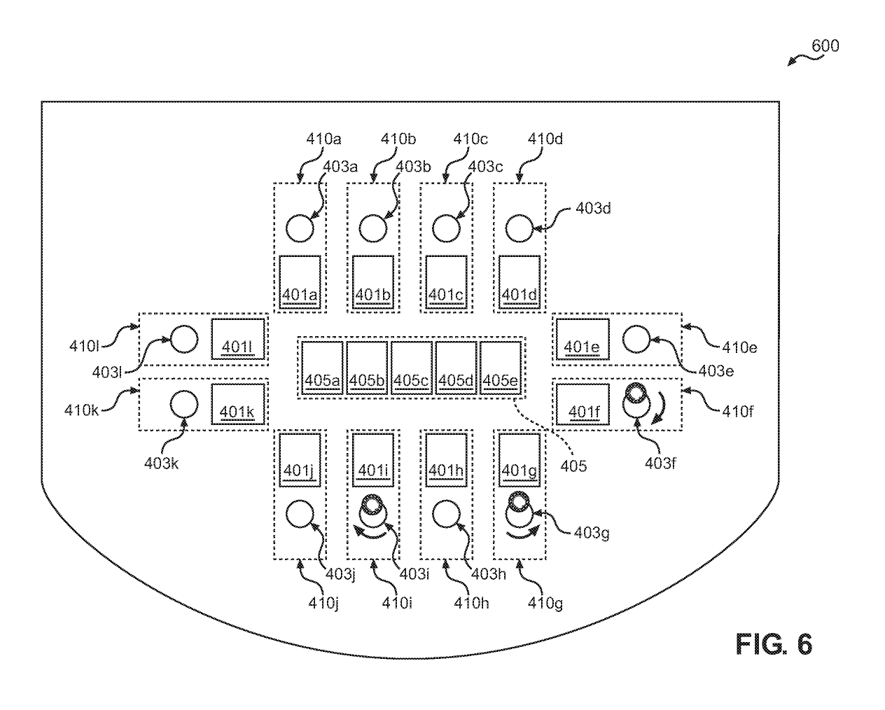

Although a card game as described herein may be implemented using an electronic representation of a card table layout in an electronic game (e.g., a card game playable online via a web browser) and FIGS. 4A and 4B (as well as FIGS. 5 and 6) illustrate various example layouts for an electronic game interface, in other embodiments such a card game may be implemented on a physical card table which may be configured (e.g., the felt layout may be arranged) in a manner similar to that shown in FIGS. 4A, 4B, 5 and 6.

Illustrated in FIGS. 4A and 4B is a particular and example game interface (referred to as game interface 400A with reference to FIG. 4A and game interface 400B with reference to FIG. 4B) which includes a plurality of card positions 410a through 410l, arranged in a circle configuration. As can be appreciated from viewing the arrangement of card positions in FIGS. 4A and 4B, the twelve (12) card positions 410a through 410k are arranged in a finite sequence arranged in an unending configuration such that the “last” card position in the sequence (card position 410k) is considered to be adjacent to the “first” card position in the sequence (card position 410a) such that the sequence of card positions effectively has no terminus or end point (the reference to “first” card position and “last” card position being primarily for convenience and clarity of referring to particular card positions). Each card position includes a respective area 401a-401k into which a single dealt card is placed and a respective wager spot 403a-403k, for indicating a wager and selected card position selected by a player. In accordance with some embodiments, the dealt cards placed into the plurality of card positions 410a-410k are cards based upon which player hands may be defined (a given player hand being defined based on a corresponding selected card position from the sequence, as selected by a player associated with the player hand).

In some embodiments, a dealer hand is also dealt and utilized to determine whether a player hand is a winning hand. For example, in a poker-style game a given player hand may be compared to the dealer hand and/or other player hands to determine whether the given player hand is a winning hand (a comparison to a dealer hand may also be part of a process in determining whether a player hand is a winning hand in a blackjack-style game or other types of card games). In some embodiments in which a dealer hand is utilized, specially designated card positions may additionally be included in the game interface for placement of cards comprising the dealer hand. FIGS. 4A and 4B include a five-card dealer hand area comprising card positions 405a-405e. In other embodiments, a subset of the card positions from which player hands are defined (e.g., a subset of the card positions 410a-410k in the game interface of FIGS. 4A and 4B) may be designated as card positions comprising the dealer hand. In some embodiments, a dealer hand is not utilized. For example, whether a player hand is a winning hand may be determined based on a payout table or schedule of winning hands or winning categories of hands (e.g., as in many video poker games, utilizing hand categories such as those illustrated in Table 2 above) and/or by comparing a given player hand to other player hands in the same game event (e.g., best player hand wins).

The example of FIG. 4A illustrates two (2) distinct wagers as having been placed on the game event being conducted. The two distinct wagers may be, for example, wagers placed by the same player (e.g., in a single player embodiment) or wagers placed by two different players (e.g., in a multi-player embodiment). It should be noted that in some multi-player embodiments a plurality of players may place a wager which indicates the same card position as a selected card position and the game interface may reflect such an occurrence. For example, a bet spot corresponding to a card position which has been selected by a plurality of players as a selected card position may, for example, indicate the number of players who have selected this card positions (e.g., if three different players selected the card position, the bet spot corresponding to the card position may show three different wagering chips and/or the number “3”). In the example being illustrated in FIG. 4A, game interface 400A indicates (i) that a player has placed a first wager and selected card position 410b as being the card position based upon which a first player hand for the first wager is to be determined, by outputting a virtual representation of a gaming chip in wager spot 403b of card position 410b; and (ii) that a player has placed a second wager and selected card position 410c as being the card position based upon which a second player hand for the second wager is to be determined, by outputting a virtual representation of a gaming chip in wager spot 403c of card position 410c. Of course, any other desirable mechanism for indicating a selected card position and wager placed by a player may be utilized. In some embodiments, an amount or magnitude of a wager corresponding to a particular selected card position may also be indicated in the bet spot corresponding to the selected card position. In some embodiments, a player placing a wager may be able to select an amount of the wager while in other embodiments the wager amount may be predetermined and not customizable or variable.

In accordance with some embodiments, that cards have been dealt and placed face down in each of the card positions 410a-410l (and, in some embodiments, into each of the dealer hand card positions 405a-405e) prior to a player placing a wager and/or prior to betting being closed for the current game event. In other embodiments, cards may not be dealt and/or placed into at least some card positions until after a player has placed a wager and/or betting has closed for the game event. In some embodiments, none of the cards may be revealed to any player until after players have placed their wagers and/or betting on the game event has closed. In some embodiments, however, the value of one or more cards may be revealed (e.g., one or more cards may be placed face up in the card positions) before wagers are finalized or player decisions are made (e.g., prior to player selecting their selected card position(s) for wager(s) being placed). For example, in one embodiment cards in certain designated positions in the finite sequence of card positions may be placed face up (e.g., in a circle configuration of card positions, the cards in the cardinal points of the circle (e.g., card positions 410a, 410d, 410g and 410j of FIG. 4A) may be placed face up. If the number of cards between these revealed cards is small enough, a player may potentially have information giving one or even two cards of any potential five card hand, thus allowing the player to make a wagering decision based on some known card information. In some embodiments, one or more cards may be revealed to a player in exchange for consideration provided by the player (e.g., an additional payment or wager amount, decreased odds of winning, decreased payouts, etc.). In some embodiments, one or more cards may be revealed only to qualifying players (e.g., players who have earned or won a privilege in the game, player who have wagered a minimum amount, players who are associated with a certain rating or category, etc.). In the embodiment illustrated in FIGS. 4A and 4B, it may be assumed that cards have been dealt and placed into each of the available card positions face down (even though the cards are not illustrated in FIG. 4A) and that the cards are not turned face up until after betting for the game event has closed and/or all wagers for the game event have been received.

As described herein, in accordance with some embodiments a player hand for a particular wager is determined by selecting for the player hand a subset of the dealt cards, the subset including the card in the selected card position plus additional cards which are determined to be the cards placed in a particular number of card positions (the particular number being either defined by the rules of the game or by the player who placed the corresponding wager) which occur in the finite sequence in a particular direction from the selected card position (the particular direction being either defined by the rules of the game or by the player who placed the corresponding wager). In the embodiment of FIGS. 4A and 4B, the number of cards determined for a player hand is 5 (e.g., the game is played based on traditional 5-card poker hand rankings) and the direction of play (i.e., the direction from the selected card position in which the additional 4 cards for the player hand are selected) is clockwise. Thus: (i) the player hand for the first wager which includes the selected card position 410b (labeled in FIGS. 4A and 4B as “Player Hand 1”) includes card positions 410b, 410C, 410d, 410e and 410f; and (ii) the player hand defined for the second wager which includes the selected card position 410c (labeled in FIGS. 4A and 4B as “Player Hand 2”) includes card positions 410c, 410d, 410e, 410f and 410g.

Turning now to FIG. 4B, in the stage of the game event being illustrated therein each of the dealt cards placed in the card positions 410a-410l and 405a-405e have been revealed to the player(s). Assuming traditional poker hand rankings are used in the game, the composition of Player Hand 1 (A^{C}-K^{H}-K^{D}-6^{H}-6^{D}) indicates that this hand is a Two Pair and the composition of Player Hand 2 (K^{H}-K^{D}-6^{H}-6^{D}-K^{S}) indicates that this hand is a Full House. The dealer hand composition does not qualify as any ranking card combination. If, in accordance with some embodiments, any player hand which falls into one of the winning hand categories is considered a winning hand irrespective of the dealer hand composition or the composition of other player hands in the game event, each of Player Hand 1 and Player Hand 2 may be considered a winning hand (this would be the case even if a player hand had to beat a dealer hand in order to be considered a winning hand, since in the present example the dealer hand is not a ranked hand category). If only the best or highest ranking player hand wins any given game event, then Player Hand 2 may be considered the winning hand for the game event since a Full House beats a Two Pair in traditional poker hand rankings.

In accordance with some embodiments, a player who has placed a wager on a game event and selected a selected card position for the wager may also be informed of the values of cards which are not part of the player hand defined for the wager (e.g., cards placed within card positions defining another player's player hand and/or cards which are not part of any player hand). In such embodiments, revealing the other cards may add excitement to the game when players are able to view what the possible hand compositions would have been had they picked another selected card position (and, in some embodiments, a different number of cards to include in their hand and/or different direction of play). For example, in the example of FIG. 4B, the player(s) participating in the game event may find it interesting to find, after all the dealt and placed cards have been revealed, that they could have won for a Straight Flush had they selected card position 410i for their wager (since, in accordance with the embodiment being illustrated in FIG. 4B, the hand composition for a five-card hand determined clockwise from card position 410i would have been 7^{H}-8^{H}-J^{H}-10^{H}-9^{H}). Additional cards which are not part of a player's hand may be revealed at the same time cards which are part of a player hand are revealed or at another time (e.g., after a small time delay from when the player hand cards are revealed).

Referring now to FIG. 5, illustrated therein is an alternate layout for a card game consistent with some embodiments, depicted in an example game interface 500. The game interface 500 includes, like game interfaces 400A and 400B, a plurality of card positions 410a-410l, each card position including a respective area 401a-401l into which a dealt card is placed and a respective bet spot 403a-403k which may be used to indicate a selected card position and/or a wager placed by a player. However, instead of an area 405 including five (5) card positions 405a-405e, the area 405 includes only two positions 405a and 405b. In accordance with some embodiments, these two card positions may (much like in the embodiments of FIGS. 4A and 4B) be utilized for placement of cards comprising a dealer hand (e.g., in a blackjack-type card game or other card game in which the dealer hand comprises only two cards). However, in other embodiments, the area 405 may be utilized for card positions into which “community” cards are dealt. Community cards may be cards which may or must be incorporated into a given player hand, such that these cards are used to add cards to (or replace cards in) a player hand otherwise defined based on a selected card position selected by a player from the plurality of card positions 410a-410i.

Referring now to FIG. 6, illustrated therein is an alternate layout for a card game consistent with some embodiments, depicted in example game interface 600. The card positions in game interface 600, like the card positions in game interface 500, are configured in a finite sequence arranged in an unending configuration. However, rather than being arranged in a circle unending configuration the cards are arranged in a rectangle unending configuration. This alternate layout is provided to illustrate that the embodiments described herein are not limited to a circle or circular shaped configuration. Any configuration in which the card positions are arranged in a finite sequence configuration which wraps around and has no terminus such that the “last” card position (e.g., card position 410l in FIG. 6) is considered immediately adjacent to the “first” card position in the sequence (e.g., card position 410a in FIG. 6) may be utilized. Thus, for example, if a player were to select card position 410k and a player hand were to include 3 cards which include (i) the card in the selected card position; and (ii) the cards in the next two card positions to the right of the selected card position, the player's hand would be determined to comprise the card in card position 410k, the card in card position 410l and the card in card position 410a. The embodiment of FIG. 6 further illustrates explicitly that in some embodiments different player hands may be determined in different directions of play (e.g., based on a direction of play selected by a player when making a wager). Thus, in the example shown in game interface 600: (i) the direction of the arrow shown in card position 410f indicates that the corresponding player hand for this wager will be determined by selecting the cards in card positions located clockwise to the selected card position 410f; (ii) the direction of the arrow shown in card position 410g indicates that the corresponding player hand for this wager will be determined by selecting cards in card positions located counter-clockwise to the selected card position 410g; and (iii) the direction of the arrow shown in card position 410i indicates that the corresponding player hand for this wager will be determined by selecting the cards in card positions located clockwise to the selected card position 410i.

Allowing a player to select a direction of play (a direction from the selected card position in which additional card positions are selected in order to form the player hand for the wager) may, if this feature is provided in accordance with some embodiments, attract player who desire additional decisions in their game play which allow them additional influence over the result of their hand. In embodiments in which cards are dealt and placed into card positions prior to a player selecting a selected card position and/or direction of play, allowing a player to select a direction of play may significantly impact the result of a game event. For example, referring again to the cards placed and revealed in game interface 400B of FIG. 4B, it can be appreciated that (assuming an embodiment in which the player been allowed to select a direction of play) if the player associated with Player Hand 1 had selected a counter-clockwise direction of play such that the cards in card positions 410b, 410a, 410l, 410k and 410j had defined the player's hand, the player would probably not have qualified for a payout because the cards in these hand positions (A^{C}-9^{H}-10^{H}-J^{H}-8^{H}) do not fit into a traditional category of winning poker hand (assuming traditional winning poker hands were being utilized to determine whether the player's hand is a winning hand). However, assuming the player had selected a clockwise direction of play (or that the clockwise direction of play is the predetermined or default direction of play, if a player is not allowed to select a direction of play), the cards in the card positions 410b, 410c, 410d, 410e and 410f qualify as a Two Pair winning hand category and the player may receive the corresponding payout.

Referring now to FIG. 7, illustrated therein is a process flowchart depicting an example process 700 which is consistent with some embodiments described herein. Process 700 facilitates a game event for a card game consistent with embodiments described herein, from the dealing of cards into a finite sequence of card positions arranged in an unending configuration, to receiving a wager from a player, defining the subset of the card positions which define the player's hand, determining the composition of the player's hand based on the cards placed in this subset of card positions and providing a payout to the player if the player's hand is a winning hand which satisfies the conditions of the player's wager. Process 700 may be performed, for example, by at least one of a server device operable to facilitate an electronic (e.g., online) card game and/or a player device enabling a player to play the electronic (e.g., online) card game. For example, process 700 may be performed by at least one of (i) a player device 102 (FIG. 1); (ii) a game server 110 (FIG. 1); (iii) a player device 202 (FIG. 2); (iv) a game server 210 (FIG. 2); and (v) apparatus 300 (FIG. 3). It should be noted that additional and/or different steps may be added to those depicted in the flowchart of FIG. 7 and that not all steps depicted are necessary to any embodiment described herein. Rather, process 700 is an example process of how some embodiments described herein may be implemented, and should not be taken in a limiting fashion. A person of ordinary skill in the art, upon contemplation of the embodiments described herein, may make various modifications to process 700 without departing from the spirit and scope of the embodiments in the possession of applicants.

The process 700 may begin, for example, by determining a plurality of cards dealt for a game event (702). In accordance with some embodiments, a plurality of cards may be dealt and made available for wagering upon. For example, as illustrated in FIGS. 4A-4B, 5 and/or 6, twelve (12) cards may be dealt and placed face down and made available for wagering to one or more players (e.g., the dealt cards may be made available to online players participating in the card game remotely, such that any of the players may choose to place a wager for the game event). Of course the embodiments described herein are not dependent on any particular number of cards being dealt although the number of cards dealt may be selected based on what is reasonable to display in a game interface for a game event. Step 702 may comprise, for example, requesting a receiving the dealt cards, or data based upon which the dealt cards may be determined (such as a random number or pseudo random number) from another device (e.g., a second server if the process 700 is being performed by a first server). In one embodiment, the device which is performing step 702 may select or determine the dealt cards directly. In one embodiment, determining dealt cards may comprise determining cards dealt by an electronic shoe (an electronic device which shuffles and deals one or more decks of cards). In some embodiments the dealt cards may be determined from a single deck of cards while in other embodiments the dealt cards may be determined from a plurality of decks of cards.

In some embodiments, step 702 may comprise determining dealt cards to use for card positions from which only player hands will be determined, including cards for community card positions (e.g., such as card positions 405a and 405b of area 405 in FIG. 5). In some embodiments, step 702 may comprise also determining cards dealt to a dealer hand. In one embodiment a dealer hand may be formed from cards dealt to designated dealer card positions (e.g., as illustrated in FIGS. 4A and 4B) while in other embodiments a dealer hand may be formed from at least one card position in the finite sequence of card positions used to form player hands. In one embodiment, cards may be dealt for a game event in response to a request from a player (e.g., a player initiates or requests to initiate a game event for which the cards are dealt). In other embodiments, cards are dealt for a game event without a request from a player, and the dealt cards are made available for wagering by one or more players (e.g., betting is “open” for some period of time after cards are dealt and/or placed, to one or more players).

In some embodiments, step 702 may comprise dealing or determining cards to be utilized for the game event based on decisions of the player or other events in the game event. For example, step 702 may include dealing at least one card to be used as a replacement card, if in an embodiment a feature allows a player to replace a card initially placed into the sequence of card positions. Such a card may not initially be placed but may be held in memory/reserve, for possible later use in the game event. In another example, step 702 may include dealing at least one card to add to a dealer hand (e.g., in a blackjack type game in which cards may be added to an initial dealer hand based on one or more predetermined rules). In other embodiments, additional cards needed as a game event progresses (e.g., a replacement card for a player hand, an additional card for a dealer hand, etc.) may be dealt later in the process in a distinct step, if such a card(s) is needed.

In step 704, at least some of the dealt cards determined in step 702 are placed into a finite sequence of card positions arranged in an unending configuration (e.g., a sequence of card positions such as those illustrated in FIGS. 4A-4B, 5 and/or 6). An unending configuration of a finite sequence of card positions may also be referred to as a wraparound finite sequence of card positions. In one embodiment, a single card of the dealt cards is placed into each available card position (e.g., a single card is placed into each of the card positions 410a-410l, 405a and 405b). In some embodiments the cards may be placed in an order in which they were dealt while in other embodiments the cards may be placed in an order different from an order in which they were dealt (e.g., in random order or in accordance with another mechanism). In embodiments including community cards and/or dealer cards, step 704 may further comprising placement of cards into community card positions and/or dealer card positions. The embodiments described herein are not dependent on any particular manner of placing the dealt cards in the game interface. In some embodiments, the dealing and placement of cards may be handled contemporaneously as effectively a single step in the process.

In some embodiments, all the dealt cards may initially be placed in a manner such that the value of the cards is not visible or otherwise discernible to the player (e.g., the cards may be placed face down) and may remain face down until betting for the game event is closed (i.e., until a stage in the game event when wagers are no longer accepted). In a single player embodiment in which a player is only allowed to place a single wager, the cards may remain face down until the player places his wager. In a multi-player embodiment, the cards may remain face down until all participating players have placed their wagers. In some embodiments, all cards may remain face down until the game interface indicates that wagers are no longer being accepted (e.g., a “bet” button or other mechanism for placing wagers is disabled or de-activated).

In some embodiments, some of the placed cards may initially (e.g., even before a wager is received from a player) be placed face up or otherwise in a manner which reveals to the player the value of these cards. For example, in some embodiments cards in certain predetermined card positions within the finite sequence of card positions may be placed face up. For example, in one embodiment in which the finite sequence of card positions is arranged in a circle configuration cards placed in the card positions comprising the ordinal points along the circle may be placed face up (e.g., the cards in card positions 410a, 410d, 410g and 410j of game interface 400A of FIG. 4A).

In some embodiments a player may be associated with a particular card position of the finite sequence of card positions (and, in some embodiments, more than one player may be associated with a particular card position). For example, a player's position relative to the finite sequence of card positions may be based on a player's “seat” at a table of cards (or a virtual table of cards, in the case of an online or other electronic card game) and/or the player's selected card position. In some embodiments, a card in a card position associated with a particular player may be revealed prior to betting being closed for the game event. For example, the selected player card or card in a card position otherwise associated with a particular player may be revealed. The card may be revealed to at least the player with whom its card position is associated but, in some embodiments, may also be revealed to other players participating in the game event (e.g., the other players seated at the poker table in a poker-type card game). In some embodiments, cards are revealed in an order as players increase their bets or fold out of the game. If betting is not yet closed as such cards are revealed, betting strategies and player decisions may then be influenced by the revealed cards (e.g., as players know what cards are in play at other player positions). In an alternate multi-player (or multi-wager embodiment, even if multiple wagers on a game event are placed by the same player) the cards at particular card positions associated with particular players or particular wagers (e.g., cards in selected card positions) may remain face-down or otherwise unrevealed while the cards in between these positions may be revealed during the course of the game event and before betting is closed for the game event. In one embodiment, a card in a randomly or pseudo-randomly determined card position may be revealed or placed face-up prior to betting on the game event being closed.

In step 706, an indication of a wager is received from a player. In accordance with some embodiments, multiple distinct wagers may be received from the same player or from a plurality of players based on the same common cards dealt and placed for a particular game event. In accordance with some embodiments, the indication of the wager includes an indication of a selected card position associated with that wager. As described herein, a selected card position may comprise a card position based on which a player's hand is defined for that wager because, in accordance with at least some embodiments, a player's hand for a particular game event consists of a subset of the dealt and placed cards, the subset including at least the card in the selected card position. In some embodiments, an indication of a wager may include an indication of one or both of the following factors for defining a player hand for the wager: (i) a direction of play; and (ii) a number of cards to include in the player hand. In some embodiments, one or both of these additional factors may be predetermined (i.e., may not vary from game event to game event, at least not in some phases, versions or stages of the game) or determined on behalf of the player based on information associated with the game event and/or player. For example, the direction of play and/or number of cards to include in the hand may be determined based on at least one of: (i) a size of the player's wager; (ii) a rating or category of the player (e.g., which may be determined based on skill, prior wagering decisions, frequency of play, average wager, etc.); (iii) a characteristic of a “table” (virtual or physical) at which the game event is occurring (e.g., one table may be designated as a “5 card” table, while another table may be designated as a “3 card” table and players may make a decision as to the size of their hand by electing to join one table vs. another); and (iv) a number of players participating in the game event.

In some embodiments, the number of cards to be included in a player hand for a wager may influence the odds or payout magnitude associated with the wager (whether the number of cards is selected by the player or otherwise). In some embodiments, the odds and/or payout may be impacted differently for different categories of winning hands. For example, in a poker-type card game a hand consisting of three (3) cards may payout out at longer odds for Three of A Kind than would a five (5) card hand but at shorter odds for all red cards, flushes or other categories of winning hands. In another example, selecting a three (3) card hand versus a five (5) card hand may result in a higher probability of obtaining a straight but the straight would be associated with a smaller payout or prize than would a straight obtained with a five (5) card player hand. In embodiments in which a player may select the number of cards to be included in their player hand, having the odds and/or payout be influenced or determined by the number of cards provides the player with an opportunity to have some control over the volatility of the game. In embodiments in which the number of cards comprising a player hand may need to be determined separately for each wager (because the number of cards defining the player hand may vary, whether based on a player selection or otherwise) the odds and/or payout for particular winning hands may need to also be determined for that wager. The odds and/or payout may be determined, for example, by (i) calculating such dynamically based on a stored algorithm; or (ii) selecting one of a plurality of available payout or probability tables for use in determining a result of the wager (e.g., a game program may access a first payout table for determining a result of a three (3) card hand, a second payout table for determining a result of a four (4) card hand, a third payout table for determining a result of a five (5) card hand, etc.).

In some embodiments, a side bet feature may be enabled, which allows a player to elect to place one or more side bets on the game event. In such embodiments, step 706 may further include receiving an indication of a side bet. In some embodiments, a side bet may be directed to cards other than the cards defining the player's hand for the player's primary wager. For example, in one embodiment a side bet may provide an award if each of the cards placed in finite sequence of card positions (e.g., each of the twelve cards placed in card positions 410a-410l of FIGS. 4A and 4B) share some predetermined characteristic (e.g., all the cards are red or all are black). In another example, a side bet may provide an award if the cards placed in the finite sequence of card positions include some predefined continuous run of cards (e.g., a seven (7) card straight, a seven (7) card royal flush). In some embodiments, such a continuous run may need to include cards (or at least one card) within the player's hand in order for the player to win the side bet while in other embodiments a player may win such a side bet if the predefined continuous run occurs anywhere in the finite sequence of card positions.

In one embodiment, a side bet opportunity may be created when a first player hand overlaps with a second player hand. The second player hand may comprise a player hand for a second wager placed by the same player or by another player. For example, referring again to the example of FIG. 4B, a side wager opportunity may be created based on the overlap of Player Hand 1 and Player Hand 2: the same card positions 410c, 410d, 410e and 410f are included in both of these player hands. Thus, a player (whether it is the same player, if both player hands are associated with the same player or either player if it is two different players who are associated with the two player hands) may choose to place a side wager that some predetermined winning combination of cards will be revealed in the overlapping card positions (e.g., the overlapping card positions may create a special four (4) card hand on which a side bet may be placed). A similar side bet opportunity may be created in embodiments in which there is overlap between a player hand and a dealer hand. In some embodiments, process 700 (or another process or subroutine consistent with embodiments described herein) may comprise determining (i) whether there is any overlap between two or more hands being defined for a game event; (ii) determining a side wager should be offered for a special hand defined by the cards in the overlapping card positions (e.g., in some embodiments there must be a minimum of overlapping card positions, such as three (3) in order for a side bet to be offered); (iii) determining a wager and/or payout size to offer for the side bet (e.g., in some embodiments the payout table may be selected based on the number of cards comprising the special side bet hand, much like a payout table may be selected based on a number of hands in a player hand); and (iv) modifying a game interface to make the side wager available to one or more players (e.g., activating a side bet button, outputting the paytable and side bet wager information, highlighting the card positions comprising the side bet, etc.).

Once the wager(s) for the game event are received (or as wagers are received, in some embodiments in which wagers may be received within some window of time during which betting for the game event is open), the card positions corresponding to each wager is determined. As described herein, a hand (e.g., a player hand, a side wager special hand) corresponding to a wager is defined by determining the card positions to be included in the hand. In accordance with some embodiments, the card positions for a given player hand are determined by including the selected card position and at least one additional card position which is determined based on the number of card positions in the hand and the direction of play for the hand. The card positions are selected based on the unending configuration of the sequence of card positions, such that if each card position in the sequence is assigned a unique identifier (e.g., a-n, if there are n card positions in the finite sequence of card positions) then the n card position is considered to be immediately adjacent (e.g., to the left of) the a card position. For example, referring to the linearly arranged finite sequence of card positions in Table 1 above and as described above, if a player had selected card position 8 as his selected card position and the player hand associated with the wager were to be defined by selecting an additional four (4) cards to the right of this selected card position, defining the card positions for the player's hand in step 708 may comprise selecting card positions 8, 9, 10, 1 and 2 as defining the player's hand. Similarly, referring now to the example of FIG. 4A, if a player has selected card position 410k as his selected card position, and the player hand associated with the wager were to be defined by selected an additional four (4) cards in a clockwise direction, step 708 may comprise defining the player hand by selecting card positions 410k, 410l, 410a, 410b and 410c. In embodiments in which one or more community cards are also included in a player hand, step 708 may further comprise determining the community card positions as being within the set of card positions defining the player hand.

In some embodiments, a player may be allowed to change the selected card position based upon which the player hand for the player's wager is determined. For example, after some point in the game event (e.g., after betting has closed or after at least one card for the player hand has been revealed to the player, based on the player's initial selection of a selected card position), the player may be allowed to change to a different selected card position for the same wager (e.g., in exchange for a fee or additional cost or if the player or wager qualifies, such as if the player had wagered a maximum wager amount).

In some embodiments which include a dealer hand, step 708 (or a different step or subroutine) may comprise determining the card positions defining the dealer hand. In some embodiments which include a dealer hand the card positions defining the dealer hand may be predefined (whether in a distinct area of the game interface, such as area 405 of FIGS. 4A and 4B) and thus there may not be a need to determine the card positions defining the dealer hand/

In step 710 the composition of each player hand (and, in embodiments in which a dealer hand is being utilized, the composition of the dealer hand) is determined based on the cards previously placed into the card positions defining the player hand (as determined in step 708). In some embodiments the cards comprising the player hand had been placed into the available card positions at an earlier point in the process. However, the embodiments described herein are not limited to any particular time at which cards are placed into card positions. For example, in some embodiments cards may be placed into card positions contemporaneously with, or even after, cards defining the player hand are determined. However and whenever the cards dealt for the game event are placed into particular card positions, the game program may store in memory (e.g., a temporary memory which stores information for a current status of a game event) an indication of the value of each card placed in each respective card positions. Thus, step 710 may comprise retrieving from memory or otherwise determining the respective values of the cards placed in the card positions defining the player hand (and, in some embodiments, any special side bet hand active for the current game event).

In step 712, at least some of the dealt cards which have been placed in card positions are revealed to a player who has placed a wager on the game event for which the cards have been dealt (e.g., the cards are turned face up so that the suit and rank of the cards is known to the player). In some embodiments, at least the cards comprising the player hand of the player are so revealed (or the remainder of such cards, if some had previously been revealed to the player in accordance with some embodiments). In some embodiments, all of the cards in the sequence of card positions for the game event are revealed, such that the player may know not only the result of his/her hand but also be aware of other possible winning hands the player could have had if he/she had selected a different selected card position (and, in embodiments in which additional choices for building a player hand are made available to the player, a different number of cards and/or a different direction of play). In some embodiments, the cards are revealed to the player concurrently with the player hand being defined (e.g., at least the cards comprising the player's hand are flipped over as soon as the player places or finalized his wager by selecting a selected card position (and, in some embodiments, a number of cards and/or direction of play)) while in other embodiments cards are revealed upon an occurrence of another predetermined stage, phase or sub-event of the game event (e.g., once betting is closed for the game event).

In some embodiments, cards are revealed to a player one at a time as a player makes betting decisions (e.g., whether to draw or stand) during a game event. In such embodiments, the card positions defining a player hand (and thus cards comprising the player hand) are re-defined and adjusted as the player makes a decision whether to stand or draw an additional card. For example, in a blackjack-type game, a player who has placed a wager on the game event may be attempting to reach a particular value (determined by summing the values of the individual cards in the player hand) without going over the value. The player may initially select a selected card position from which their initial player hand is determined. The card in the selected card position may be revealed to the player. In some embodiments a second card (in one direction from the player selected card position, whether the direction be selected by the player or determined based on rules of the game or otherwise) may additionally be revealed. The player may then be provided an opportunity to either stand (not add any additional card to their hand) or draw (add another card to their hand). If the player decided to draw, the card in the next card position (e.g., in the same direction of play as utilized to determine the second card) may be revealed to the player and added to the composition of the player hand. For example, assume the card revealed to the player in the selected card position is a “2” and the next card in the direction of play is revealed to be an Ace. The player hand may now be considered to be a “high card Ace.” The player may then choose to draw an additional card, in which case the card in the next card position in the direction of play would be revealed. In accordance with some embodiments, the more cards revealed and added to the player hand, the lower the payback will be for beating the dealer hand. In the current example, the player may decide to stand, not have any more cards revealed and added to his player hand of Ace high and hope that the dealer has a poor hand. In such embodiments, revealing the card values, determining the composition of the player hand and determining whether the player hand is a winning hand may in some ways be conflated or occur more simultaneously than in other embodiments.

In step 714 a payout or other prize is provided to a player if the player hand is determined to be a winning hand. Whether the player hand is a winning hand may be determined during one of various steps in the process 700. For example, whether the player hand is a winning hand may be determined once the composition of the player hand is determined (e.g., as part of, or based on, the determination of the composition of the player hand). While in some embodiments there may be multiple winning hands (and thus multiple payouts) determined for a given game event (e.g., based on player hands defined from the same set of dealt and placed cards, based on respective selected card positions associated with each wager placed on the game event), in other embodiments there may only be one winning hand (whether it be a player hand or a dealer hand) for a game event. In some embodiments which include a side bet feature, the determination of whether any special hands created for side bets placed may be a separate determination from determining which player hand(s) are the winning hand(s) for the game event.

In some embodiments (both in single player games and multi-player games), a player placing a wager on a game event is playing against a fixed paytable (much like in video poker or a slot machine game), with the paytable payouts being influenced by the number of cards defining the player's hand. Thus, for example, a paytable may include winning categories of hands (e.g., such as those illustrated in Table 2 herein) and a player's hand may be determined to be a winning hand if it falls within any of the defined categories of winning hands (e.g., a Flush, a Straight, etc.). In some embodiments, a player may select particular categories of hands (s)he is betting will be included in his/her player hand (e.g., a Flush). In such embodiments, payouts for the winning hand categories selected by the player may be influenced by the number of winning hand categories the player is including in their wager (e.g., a payout for a Flush may be higher if the player is only betting on a Flush occurring vs. if the player is betting on a Flush and additional winning categories of hands). In embodiments in which a player is playing against a paytable, determining whether a player hand is a winning hand may simply comprise comparing the composition of the player hand to the winning hands or categories of winning hands included in the appropriate paytable (e.g., the appropriate paytable being selected or determined based on the number of cards in the player hand and/or the wager amount associated with the player hand). In embodiments in which a player is playing against a fixed paytable, if the player hand matches or falls within a category of winning hands in the paytable, the corresponding payout (e.g., as indicated in the paytable) may be provided to the player. Similarly, if a side bet special hand matches or falls within a category of winning hand or a qualifying winning hand, a corresponding payout is provided to the player who placed the side bet.

In some embodiments (both in single-player games and multi-player games), a player hand is compared to at least one other player hand (whether it be another player hand of the same player or another player hand of another player) in order to determine whether it is a winning hand. In such embodiments, determining which player hand is the winning hand for a game event may comprise comparing the composition of the player hand against the composition of every other player hand being played in the game event. For example, the best player hand (e.g., the player hand corresponding to the highest payout) of all player hands created in a given game event may be determined to be the winning hand. In embodiments in which players are playing against each other, the payout or prize provided for the winning hand may be a pot or amount which is based on the wagers placed on the game event (e.g., a sum of the wager amounts minus a percentage or fee taken by the gaming establishment which provides the game).

In some embodiments (again, both in single-player games and multi-player games) a player is playing against a dealer such that determining whether a given player hand is a winning hand comprises determining whether the player hand beats the dealer hand. This may comprise determining the composition or value of a given player hand, determining the composition or value of the dealer hand and determining which hand is the winner. In such embodiments, a result of a player hand being determined to be a winning hand is that the associated player is provided a payout or prize which is, for example, based on the wager placed by the player (and, in some embodiments, the odds of winning the wager which may be based on a number of cards defining the player hand), the total wagers placed on the game event, or a predetermined amount based on the composition of the player hand.

Providing a payout or other prize to a player may comprise, for example, adding credits to a credit meter balance associated with the player, adding an amount of monetary value to a financial account associated with the player, or providing at least one physical gaming chip to a player (e.g., in embodiments in which the game is played on a physical table). In embodiments in which a prize is a non-monetary prize (e.g., a coupon, ticket or voucher for a product, service or event), providing a prize to a player may comprise storing an identifier identifying the prize in association with a player identifier identifying the player who won the prize. The embodiments described herein are not limited to any particular type of prize or manner of providing the prize to the appropriate player.

In one particular embodiment, a player is dealt a plurality of cards (e.g., after the cards are shuffled or otherwise randomized). In one embodiment, the cards are dealt in a particular configuration or pattern, such as a circle. An entire deck (or a plurality of decks of cards) may be so dealt in the particular configuration or pattern. In another embodiment, a subset of a deck (or plurality of decks) may be so dealt in the particular configuration or pattern (e.g., 10 of 52 cards, 20 of 52 cards, etc.); the embodiments described herein are not reliant on any particular number of cards being dealt. In one embodiment the cards dealt for a game event are initially dealt face down (such that a player cannot see or otherwise determine a value of the cards, such as the suit, color, number value or other characteristic of the individual cards which distinguishes them from one another). Prior to a value of any cards being revealed (e.g., prior to any cards being turned face up), one or more players may be provided with an opportunity to place at least one wager based on the dealt cards. While in some embodiments the player(s) may be allowed to place wagers once all of the cards to be dealt face down are dealt, in other embodiments a player may also be provided with an opportunity to place one or more wagers contemporaneously with the cards being dealt or even prior to any or all of the cards being dealt. For example, the player(s) may be provided with numerous wager options via an interface of the online game. In a particular example in which the game is a poker-type card game, the player may be provided with an opportunity to wager whether a subset of the dealt cards (the subset being defined as the player's hand), once revealed to the player (e.g., once they are turned face up) will include cards comprising one of the ranked categories of cards described above (e.g., three-of-a-kind, flush, straight, etc.). In other words, in some embodiments the player may be provided with an opportunity to wager on which outcomes (e.g., outcomes which correspond to a payout or other prize) will be included in the subset of cards defining the player's hand. In one embodiment, the player may be allowed to place a plurality of wagers based on the same set of dealt cards (e.g., one on each type of winning outcome the player believes will be revealed when cards are turned face up, each wager beginning with a different card position, etc.).

In accordance with some embodiments, at least some of the dealt cards are revealed or turned face up after they are dealt and the player has placed one or more wagers. The cards which are revealed or turned face up are the cards which are evaluated or considered when determining whether the player wins any of the wagers placed (the cards which remain face down or otherwise output such that the value of the cards is not discernable or revealed to the player). Thus, a determination of which (and how many) cards to reveal or turn face up is performed upon the player placing the wager(s).

In accordance with one embodiment, once the player places his/her wagers, the player is provided with an opportunity to select one specific card of the plurality of dealt cards which is to be revealed or turned face up. In other embodiments, the player may be allowed to select more than one card (e.g., for an additional fee, increased wager amount or other consideration, if the player has earned a predetermined qualification for selecting more than one card, such as earned a sufficiently high player ranking, etc.). In one embodiment, the card(s) selected by the player is turned face up along with an additional X cards (X being a number of cards which is at least one but less than the total number of cards dealt minus the card(s) selected by the player). In one embodiment, the X additional cards are the cards placed in a particular relationship to the card selected by the player (e.g., the next X cards in a clockwise direction along the circle configuration in which the cards were dealt). In another embodiment, the X cards are cards selected randomly or on another basis (the embodiments described herein are not reliant on any particular methodology for selecting which cards comprise the X additional cards).

In accordance with some embodiments, the number X (i.e., how many additional cards are revealed or turned face up in addition to the card(s) selected by the player) are selected by the player (e.g., when the player is placing the one or more wager(s)). In such embodiments, the number of cards may be related to the wager amount (e.g., the larger the number X, the higher the wager amount per wager placed). It should be noted that the number X may be related to the odds of achieving certain outcomes or categories of ranked groups of cards (e.g., flushes vs. straights vs. three-of-a-kind in a poker game). For example, in some embodiments the mathematical model may be implemented such that the smaller the number X is (i.e., the fewer additional cards are to be revealed or turned face up), the higher the odds that the cards which will be turned face up will comprise a three-of-a-kind but the smaller the odds that it will be all red cards, all black cards or comprise a flush. Thus, allowing a player to select the number X provides the player some influence on the volatility of the game. Allowing the player to select the card(s) which is revealed first also provides the player with a certain sense of influence or control over the game. In some embodiments, the number X may be a predetermined number, selected from a set of possible predetermined numbers (e.g., based on one or more of the player's wager amount(s), a player ranking, a number of wager(s) placed, or other factors). In one embodiment the number X may be determined on a random basis. The embodiments described herein are not reliant on any particular methodology of determining how many additional cards to reveal or turn face up.

Once the player has placed his/her bets, selected the one or more cards (which are revealed or turned face up), the number X has been determined and the X number of additional cards have been revealed, the revealed cards may be evaluated to determine whether the player has won any of the bets he/she placed. For example, the revealed cards may be compared to one or more possible winning combinations of cards or ranked categories of cards (such as the particular ones the player bet on) to determine whether they comprise any of these possible winning combinations which the player bet on (e.g., in a poker game, whether the revealed cards comprise a flush, full house, three-of-a-kind, etc.). The player is the provided with a payout or other prize based on which bets, if any, were winning ones.

It should be noted that although the card game described herein has been described with reference to a poker style card game, the embodiments described herein are not limited to poker card games or even card games. For example, the embodiments in a reeled slot machine type of game, a plurality of obscured game elements (e.g., reel symbols) may be output to the player in a particular configuration and the player may be allowed to bet which winning combinations of reel symbols will be revealed, then select one or more particular game elements to be revealed along with the number of additional game elements to be revealed.

Certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Although several embodiments, examples and illustrations are disclosed below, it will be understood by those of ordinary skill in the art that the invention described herein extends beyond the specifically disclosed embodiments, examples and illustrations and includes other uses of the invention and obvious modifications and equivalents thereof. Embodiments of the invention(s) are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention(s). In addition, embodiments of the invention(s) can comprise several novel features and it is possible that no single feature is solely responsible for its desirable attributes or is essential to practicing the invention(s) herein described.

### Rules of Interpretation

The terms “information” and “data”, as used herein unless specified otherwise, may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

The term “indication”, as used herein unless specified otherwise, may refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

The term “network component,” as used herein unless specified otherwise, may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

The term “player,” as used herein unless specified otherwise, may refer to any type, quantity, and or manner of entity associated with the play of a game. In some embodiments, a player may comprise an entity (i) conducting play of an online game, (ii) that desires to play a game (e.g., an entity registered and/or scheduled to play and/or an entity having expressed interest in the play of the game—e.g., a spectator) and/or may (iii) that configures, manages, and/or conducts a game. A player may be currently playing a game or have previously played the game, or may not yet have initiated play—i.e., a “player” may comprise a “potential player” (e.g., in general and/or with respect to a specific game). In some embodiments, a player may comprise a user of an interface (e.g., whether or not such a player participates in a game or seeks to participate in the game). In some embodiments, a player may comprise a virtual player (i.e., a player represented by software controlling betting decisions for a player position).

Some embodiments described herein are associated with a “player device” or a “network device”. As used herein, a “player device” is a subset of a “network device”. The “network device”, for example, may generally refer to any device that can communicate via a network, while the “player device” may comprise a network device that is owned and/or operated by or otherwise associated with a player. Examples of player and/or network devices may include, but are not limited to: a Personal Computer (PC), a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. Player and/or network devices may, in some embodiments, comprise one or more network components.

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

The Title (set forth at the beginning of the first page of this disclosure) is not to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “and/or”, when such term is used to modify a list of things or possibilities (such as an enumerated list of possibilities) means that any combination of one or more of the things or possibilities is intended, such that while in some embodiments any single one of the things or possibilities may be sufficient in other embodiments two or more (or even each of) the things or possibilities in the list may be preferred, unless expressly specified otherwise. Thus for example, a list of “a, b and/or c” means that any of the following interpretations would be appropriate: (i) each of “a”, “b” and “c”; (ii) “a” and “b”; (iii) “a” and “c”; (iv) “b” and “c”; (v) only “a”; (vi) only “b”; and (vii) only “c.”

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, component or article is described herein, more than one device, component or article (whether or not they cooperate) may alternatively be used in place of the single device, component or article that is described. Accordingly, the functionality that is described as being possessed by a device may alternatively be possessed by more than one device, component or article (whether or not they cooperate).

Similarly, where more than one device, component or article is described herein (whether or not they cooperate), a single device, component or article may alternatively be used in place of the more than one device, component or article that is described. For example, a plurality of computer-based devices may be substituted with a single computer-based device. Accordingly, the various functionality that is described as being possessed by more than one device, component or article may alternatively be possessed by a single device, component or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure may refer to a “control system” or program. A control system or program, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory” and/or “tangible media” specifically exclude signals, waves, and wave forms or other intangible or non-transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

What is claimed is:

1. A gaming system for providing a card game, the system comprising:
a processor operable to receive, over an electronic network, input from a player device and modify data on a game interface in response thereto;
a memory storing a program for directing the processor, the processor being operable with the program to:
provide a game interface which includes a plurality of card positions into which cards are placed, the card positions being configured in a finite sequence arranged in an unending configuration having a first card position, a last card position and at least one card position between the first card position and the last card position, wherein an unending configuration aspect of the finite sequence of card positions provides that the last card position in the sequence is considered to occur immediately adjacent to the first card position in the sequence irrespective of a physical placement of the last card position relative to the first card position;
cause a plurality of cards to be dealt for a game event, thereby determining a plurality of dealt cards;
place a single card of the plurality of dealt cards into each card position in the finite sequence of card positions, wherein at least one of the plurality of cards is placed such that it's value is not initially indicated to a player of the game;
determine that a player has actuated a player-selectable mechanism for placing a wager and provided, via an in input mechanism of the player device, a selection of one card position of the plurality of card positions, thereby determining a selected card position;
define a subset of card positions within the sequence to be utilized in determining a composition of a player hand of the game event for the player, the subset including the selected card position, by:
(a) determining a direction of card positions in the finite sequence, from the selected card position, for selecting card positions to be included in the subset;
(b) determining a number of card positions, in the direction and from the selected card position, to be included in the subset; and
(c) selecting for the subset a plurality of consecutive card positions, up to the number determined in (b), which occur in the finite sequence in the direction determined in (a);
determine, for each card position included in the subset, a value of a card placed in the card position, thereby determining the composition of the player hand; and
cause a prize to be provided to the player if, based on the composition of the player hand, it is determined that the player hand is a winning hand.

2. The gaming system of claim 1, wherein the number of card positions determined in (b) is a predetermined number defined by at least one rule of the game.

3. The gaming system of claim 1, wherein the number of card positions determined in (b) is selected by the player.

4. The gaming system of claim 3, wherein the processor is further operable with the program to:
determine, based on the number of card positions selected by the player, a value of the prize, such that the same winning hand may cause one of a first value to be provided to the player if the number is a first number or, in the alternative, a second value to be provided to the player if the number is a second number.

5. The gaming system of claim 1, wherein the direction determined in (a) is a predetermined direction defined by at least one rule of the game.

6. The gaming system of claim 1, wherein the direction determined in (a) is selected by the player.

7. The gaming system of claim 1, wherein the game interface further includes at least one community card position into which a card is placed and further wherein the subset includes the community card position.

8. The gaming system of claim 1, wherein finite sequence of card positions is arranged in a circle configuration.

9. The gaming system of claim 1, wherein the processor is further operable with the program to:
reveal to the player, prior to receiving the indication of the wager and after dealing the plurality of cards, a value of a card placed in at least one card position of the sequence.

10. The gaming system of claim 1, wherein game is a multi-player game and the player is a first player and further wherein the processor is further operable with the program to determine a composition for a second player hand for the second player, using the same plurality of dealt cards which are placed into the sequence of card positions for the game event:
receive from the second player an indication of a second wager, the indication of the second wager including a selection of one card position of the plurality of card positions, thereby determining a second selected card position;
define a second subset of card positions within the sequence to be utilized in determining a composition of a second player hand of the game event for the second player, the second subset including the second selected card position, by:
(a) determining a direction of card positions in the finite sequence, from the second selected card position, for selecting card positions to be included in the second subset;
(b) determining a number of card positions, in the direction and from the second selected card position, to be included in the second subset; and
(c) selecting for the second subset a plurality of consecutive card positions within the sequence, up to the number determined in (b), which occur in the finite sequence in the direction determined in (a);
determine, for each card position included in the second subset, a value of a card placed in the card position, thereby determining the composition of the second player hand; and
cause a second prize to be provided to the second player if, based on the composition of the second player hand, it is determined that the second player hand is a winning hand.

11. The gaming system of claim 1, wherein the processor is further operable with the program to:
receive from the player a request to change the selected card position; and
change the selected card position from a first card position to a second card position based on the request, thereby determining a modified selected card position.

12. The gaming system of claim 11, wherein the processor is further operable with the program to:
define a modified subset of card positions within the sequence to be utilized in determining a composition of a hand of the game event for the player by applying the modified selected card position to steps (a), (b) and (c).

13. The gaming system of claim 1, wherein the processor is further operable with the program to:
cause at least one card to be dealt for a dealer hand of the game event;
determine a composition of the dealer hand; and
determine whether the player hand is a winning hand by comparing the player hand to the dealer hand.

14. The gaming system of claim 13, wherein at least one card position into which the at least one card dealt for the dealer hand is placed is a predetermined card position within the finite sequence.

15. The gaming system of claim 13, wherein at least one card position into which the at least one card dealt for the dealer hand is placed is a card position not included in the finite sequence.

16. The gaming system of claim 1, wherein the processor is further operable with the program to:
reveal to the player, after receiving the indication of the wager, a value of each card placed into a card position included in the subset.

17. The gaming system of claim 1, wherein the processor is further operable to:
reveal to the player, after receiving the indication of the wager, a value of each card placed into a card position not included in the subset.

18. A non-transitory computer-readable medium storing instructions for directing a processor of a gaming system to perform a method, the method comprising:
providing a game interface which includes a plurality of card positions into which cards are placed, the card positions being configured in a finite sequence arranged in an unending configuration having a first card position, a last card position and at least one card position between the first card position and the last card position, wherein an unending configuration aspect of the finite sequence of card positions provides that the last card position in the sequence is considered to occur immediately adjacent to the first card position in the sequence irrespective of a physical placement of the last card position relative to the first card position;
causing a plurality of cards to be dealt for a game event, thereby determining a plurality of dealt cards;
placing a single card of the plurality of dealt cards into each card position in the finite sequence of card positions, wherein at least one of the plurality of cards is placed such that it's value is not initially indicated to a player of the game;
determining that a player has actuated a player-selectable mechanism for placing a wager and provided, via an in input mechanism of a player device which communicates with the gaming system over an electronic network, a selection of one card position of the plurality of card positions, thereby determining a selected card position;
defining a subset of card positions within the sequence to be utilized in determining a composition of a hand of the game event for the player, the subset including the selected card position, by:
(a) determining a direction of card positions in the finite sequence, from the selected card position, for selecting card positions to be included in the subset;
(b) determining a number of card positions, in the direction and from the selected card position, to be included in the subset; and
(c) selecting for the subset a plurality of consecutive card positions, up to the number determined in (b), which occur in the finite sequence in the direction determined in (a);
determining, for each card position included in the subset, a value of a card placed in the card position, thereby determining the composition of the hand; and
causing a prize to be provided to the player if, based on the composition of the hand, it is determined that the hand is a winning hand.

19. The non-transitory computer-readable medium of claim 18, wherein the number of card positions determined in (b) is selected by the player.

20. The non-transitory computer-readable medium of claim 18, wherein the direction determined in (a) is selected by the player.
